(19) United States
(12) Patent Application Publication
(10) Pub. No.: US 2005/0076310 A1
(43) Pub. Date: Apr. 7, 2005

(54) DISPLAY CONTROLLER, DISPLAY CONTROL METHOD, AND RECORDING MEDIUM WITH PROGRAM FOR EXECUTING THE DISPLAY CONTROL METHOD RECORDED THEREIN

(75) Inventor: Kenichiro TADA, Tokorozawa-shi, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/711,352

(22) Filed: Sep. 13, 2004

(30) Foreign Application Priority Data
Oct. 1, 2003 (JP) 2003-342911

(51) Int. Cl. G06F 3/00

(52) U.S. Cl. 715/838

(57) ABSTRACT

A recording/reproducing device (10) of a contents recording/reproducing system (100) according to the present invention includes a contents information generating section for fetching a date and time for reproduction of contents data, graphics for changing an expression of a thumbnail image associated with the contents data according to the number of lapsed days since the contents data is reproduced last, and a thumbnail generating section. With the configuration, the recording/reproducing device (10) changes an expression of the thumbnail image according to the number of lapsed days since the date and time when the contents data fetched with the contents information generating section is reproduced. Because of the configuration, a user can easily recognizes the number of lapsed days since the contents data is reproduced last from an expression of the thumbnail image.

### BACKGROUND OF THE INVENTION

1. Field of the Invention

The present invention relates to a display controller for displaying a representative still image associated with contents data on a display, a display control method, and a recording medium with a program for executing the display control method recorded therein.

2. Description of Related Art

There has been known a display controller for rearranging representative still images based on reproduction dates of contents data such as image data and displaying the rearranged representative pictures on a display section or the like in a menu format. In the following descriptions, the representative still image associated with contents data is described as a thumbnail or an icon.

Further there has been known a display controller for changing an expression of a thumbnail based on the time difference between a date of storage of a thumbnail or contents data in a storage device or the like and the current date and displaying the thumbnail on a display section or the like (Refer to, for instance, cited reference 1: Japanese Patent Laid-Open Publication No. HEI 10-207752, page 3 left column to page 4 right column, and cited reference 2: Japanese Patent Laid-Open Publication No. 2002-77779, page 7 left column to page 8 left column).

With the configuration in which an expression of a thumbnail is changed based on the number of days after the date of storage of the thumbnail or the contents data in a storage device or the like as in the cases of the display controllers disclosed in the cited reference 1 and the cited reference 2, there are the disadvantages, for instance, that the number of days having passed from the date of reproduction of the contents data can not be recognized from an expression of a thumbnail.

Further with the configuration in which thumbnails are rearranged and displayed according to dates of reproduction of contents data, there are the disadvantages, for instance, that, even though a sequence of dates of reproduction of contents data can be expressed, the number of days having passed from the date of reproduction can not easily be recognized.

### SUMMARY OF THE INVENTION

An object of the present invention is to provide a display controller and a display control method enabling easy recognition of the number of days having passed from the date when the data was processed, and a recording medium with a program for executing the display control method recorded therein.

A display controller according to an aspect of the present invention for controlling a display of a representative still image associated with contents data, the display controller includes: a storage section for storing a reproduction date and time of the contents data; and an expression changing section for changing an expression of the representative still image associated with the contents data based on the number of lapsed days since a reproduction date and time of the contents data.

A display control method according to another aspect of the present invention for displaying a representative still image associated with contents data, the method includes: a reproduction date and time storing step for the contents data; and an expression changing step of changing an expression of the representative still image associated with the contents data based on the number of lapsed days since a reproduction date and time of the contents data up to a display date and time of the representative still image.

A recording medium according to still another aspect of the present invention stores in the readable state a program for executing the above-described display control method.

### BRIEF DESCRIPTION OF THE DRAWINGS

FIG. 1 is a block diagram showing general configuration of a contents recording/reproducing system according to a first embodiment of the present invention;

FIG. 2 is a schematic view illustrating general configuration of contents information stored in a HDD for a recording/reproducing device in the first embodiment,

FIG. 3 is a schematic view illustrating general configuration of a main TS packet incorporated in the contents information in the first embodiment;

FIG. 4 is a schematic view illustrating general configuration of a RAM in the recording/reproducing device in the first embodiment;

FIG. 5 is a block diagram showing general configuration of a CPU in the recording/reproducing device in the first embodiment;

FIG. 6 is a flow chart illustrating a processing for recording contents data in the first embodiment;

FIG. 7 is a flow chart illustrating a processing for displaying thumbnails in the first embodiment;

FIG. 8 is a flow chart illustrating a processing for displaying thumbnails in the first embodiment;

FIG. 9 is a graph showing a relation between the number of lapsed days and an alpha value;

FIG. 10A to FIG. 10C are schematic views each illustrating a relation between a date and time when the contents data was reproduced and a date and time when a thumbnail for the contents data is to be displayed on an output device; where FIG. 10A is a schematic view illustrating a case in which contents data was reproduced on May 31, 2002 and then a thumbnail for the contents data was displayed on the same day; FIG. 10B is a schematic view illustrating a case in which a thumbnail for the contents data was displayed on Jun. 14, 2002 without reproducing the contents data from FIG. 10A; and FIG. 10C is a schematic view illustrating a case in which a thumbnail for the contents data was displayed on Jun. 15, 2003 without reproducing the contents data from FIG. 10B;

FIG. 11 is a schematic view showing a thumbnail which is displayed on the output device in the first embodiment;

FIG. 12 is a flow chart illustrating a processing for reproducing contents data in the first embodiment;

FIG. 13 is a block diagram showing general configuration of a HP displaying system according to second and third embodiments of the present invention;

FIG. 14 is a schematic view showing general configuration of a storage section of a server according to the second and third embodiments;

FIG. 15 is a schematic view showing general configuration of HP display information stored in the storage section of the server in the second embodiment;

FIG. 16 is a block diagram showing general configuration of a processing section of the server in the second embodiment;

FIG. 17 is a schematic view showing general configuration of terminal HP information stored in a memory of a terminal unit in the second information;

FIG. 18 is a block diagram showing general configuration of a CPU in the terminal unit in the second embodiment;

FIG. 19 is a flow chart illustrating a processing for generating an icon in the second and third embodiments;

FIG. 20 is a flow chart illustrating a processing for updating an access time in the second and third embodiments;

FIG. 21 is a schematic view showing general configuration of HP display information stored in the storage section of the server in the third embodiment;

FIG. 22 is a block diagram showing general configuration of a processing section of the server in the third embodiment; and

FIG. 23 is a block diagram showing general configuration of a CPU in the terminal unit in the third embodiment.

### DETAILED DESCRIPTION OF PREFERRED EMBODIMENT(S)

[First Embodiment]

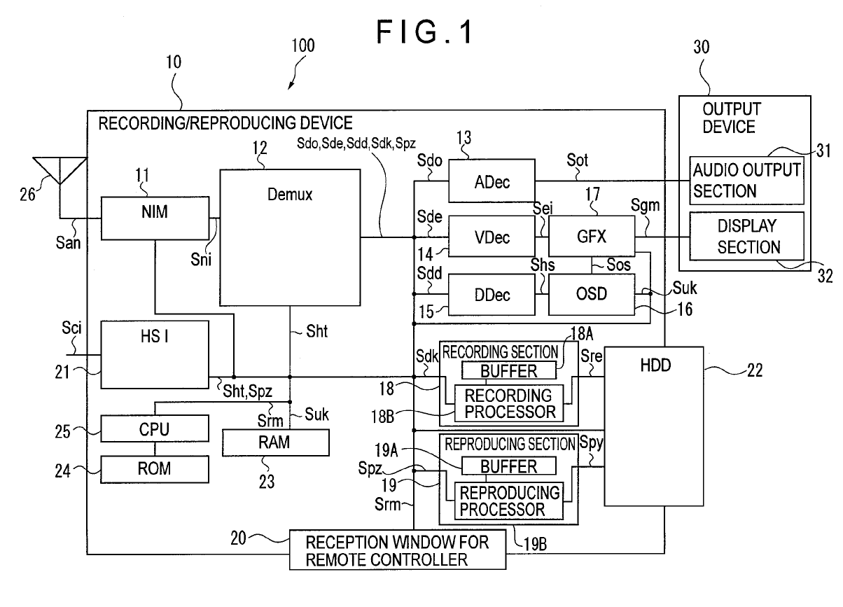

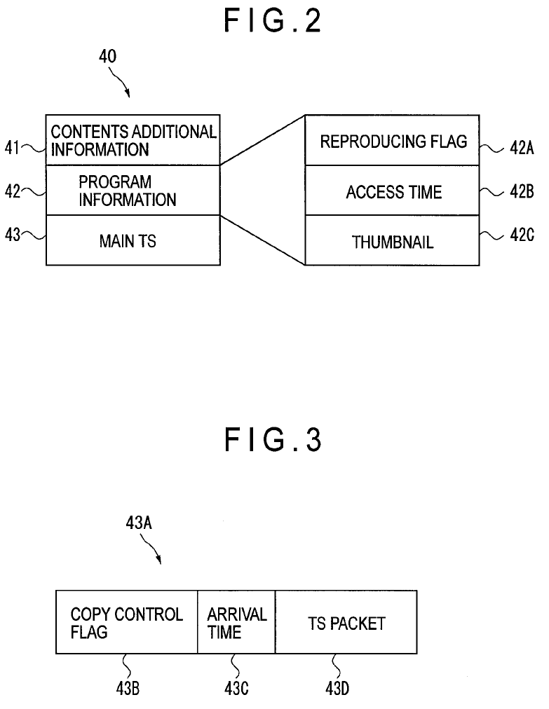

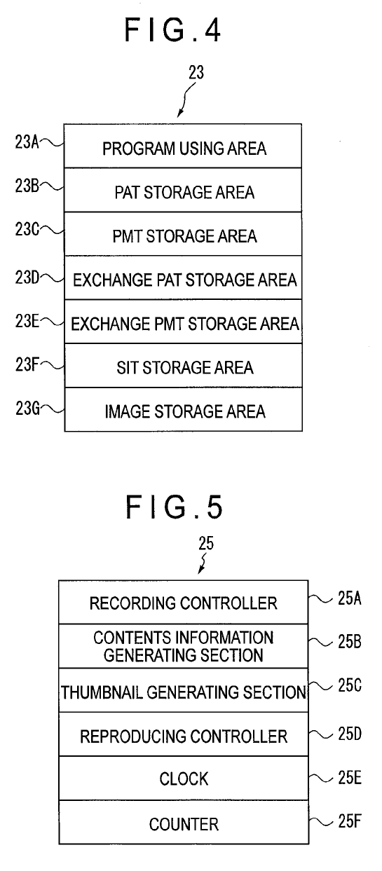

A first embodiment of the present invention is described below with reference to the related drawings. FIG. 1 is a block diagram showing general configuration of a contents recording/reproducing system in the first embodiment. FIG. 2 is a schematic view illustrating general configuration of contents information stored in a HDD of the recording/reproducing device. FIG. 3 is a schematic view showing general configuration of a main TS packet incorporated in the contents information. FIG. 4 is a schematic view showing general configuration of a RAM of the recording/reproducing device. FIG. 5 is a block diagram showing general configuration of a CPU on the recording/reproducing device.

[Configuration of Contents Recording/Reproducing System]

In FIG. 1, the reference numeral 100 indicates a contents recording/reproducing system as a display control system (described as a recording/reproducing system hereinafter), and this system changes an expression of a thumbnail as a representative sill picture associated with contents data having image data as data for reproducing contents such as a TV program recorded in a recording/reproducing device based on the number of elapsed days after the data was reproduced last for having the thumbnail with the changed expression displayed. The recording/reproducing system 100 includes a recording/reproducing device 10 as a display controller and an output device 30 as a display section.

The recording/reproducing device 10 records contents data including audio data, image data, data for data broadcasting or the like distributed as a TS (Transport Stream). Further the recording/reproducing device 10 outputs the recorded contents data according to the necessity and reproduces the data on the output device 30. Further the recording/reproducing device 10 generates a thumbnail with an expression according to the number of lapsed days after the contents data was reproduced last and has the thumbnail displayed on the output device 30.

This recording/reproducing device 10 includes a network interface module (described as NIM hereinafter) 11, a demultiplexer (described as Demux hereinafter) 12, an audio decoder described as ADec hereinafter) 13, a video decoder (described as VDec hereinafter) 14, a data decoder (described as DDec hereinafter) 15, an on-screen display (described as OSD hereinafter) 16, graphics (described as GFX hereinafter) 17 as an expression changing section, a recording section 18, a reproducing section 19, a reception window for remote controller 20, a high speed interface (described as HSI hereinafter) 21, a hard disk (described as HDD hereinafter) 22 as a storage, a RAM (Random Access Memory) 23, a ROM (Read Only Memory) 24, and CPU (Central Processing Unit) 25 and the like.

Connected to the NIM 11 is an antenna 26 for receiving, for instance, broadcast wave for digital broadcasting. Further the NIM 11 is connected to the Demux 12. In addition, the NIM 11 is connected to the CPU 25. This NIM 11 fetches a signal San received by the antenna 26 and outputted from this antenna 26. Then the NIM 11 converts the fetched signal San to a digital signal Sni corresponding to a requiring channel according to the necessity and outputs the converted signal Sni to the Demux 12.

The Demux 12 is connected to the ADec 13, VDec 14, DDec 15, recording section 18, reproducing section 19, and to the HSI 21. Further the Demux 12 is also connected to the CPU 25. This Demux 12 fetches the digital signal Sni outputted from the NIM 11 or a digital signal Sht outputted from the HSI 21 under control by the CPU 25. Then the Demux 12 fetches a specific TS packet with various types of data corresponding to a prespecified channel from the TS described in the digital signal Sni or digital signal Sht fetched as described above. Then the Demux 12 converts the TS packet with audio data incorporated therein to audio information Sdo according to the necessity and outputs the audio information Sdo to the ADec 13. The Demux 12 further converts the TS packet with video data incorporated therein to video information Sde according to the necessity and outputs the video information Sde to the VDec 14. Further the Demux 12 converts the TS packet with data for data broadcasting to data information Sdd according to the necessity and outputs the data information Sdd to the DDec 15. In the following descriptions, the TS packet with audio data incorporated therein is described as audio packet, the TS packet with video data incorporated therein as video packet, and the TS packet with data for data broadcasting incorporated therein as data packet according to the necessity.

In addition, the Demux 12 fetches a digital signal Sni outputted from the NIM 11 or the digital signal Sht outputted from the HSI 21 under control by the CPU 25. Then the Demux 12 fetches a TS packet identified with a packet ID specified by the CPU 25 from the TS described in the digital signal Sni or the digital signal Sht fetched as described above. Then the Demux 12 outputs the fetched TS packet as a recording signal Sdk to the recording section 18.

Further the Demux 12 fetches a reproducing signal Spz outputted from the reproducing section 19 under control by the CPU 25. Then the Demux 12 fetches a main TS packet 43A described in the fetched reproducing signal Spz. Then the Demux 12 converts the main TS packet 43A with audio data incorporated therein to audio information Sdo according to the necessity and outputs the audio information Sdo to the ADec 13. Further the Demux 12 converts the main TS packet 43A with video data incorporated therein to video information Sde according to the necessity and outputs the image information Sde to the VDec 14. The Demux 12 further converts the main TS packet 43A with data for data broadcasting incorporated therein to data information Sdd and outputs the data information Sdd to the DDec 15 according to the necessity. In the following descriptions, the main TS packet 43A with audio data incorporated therein is described as audio main packet 43A, the main TS packet 43A with video data incorporated therein as video main packet 43A, and the main TS packet 43A with data for data broadcasting incorporated therein as data main packet 43A respectively.

The ADec 13 is connected to the output device 30. The ADec 13 is also connected to the CPU 25. This ADec 13 fetches an audio packet or the audio main packet 43A described in the audio information Sdo outputted from the Demux 12 under control by the CPU 25. Then the ADec 13 outputs audio data incorporated in the audio packet or audio main packet 43A fetched as described above as a demodulated audio signal Sot to the output device 30.

The VDec 14 is connected to the GFX 17. Further the VDec 14 is connected also to the CPU 25. This VDec 14 fetches a video packet or the video main packet 43A described in the video information Sde outputted from the Demux 12 under control by the CPU 25. Then the VDec 14 outputs video data incorporated in the video packet or the video main packet 43A fetched as described above as audio signal Sei to the GFX 17.

The DDec 15 is connected to the OSD 16. Further the DDec 15 is also connected to the CPU 25. This DDec 15 fetches a data packet or the data main packet 43A described in the data information Sdd outputted from the Demux 12 under control by the CPU 25. Then the DDec 15 outputs the data for data broadcasting incorporated in the data packet or the data main packet 43A fetched as described above as a demodulated data signal Shs to the OSD 16.

The OSD 16 is connected to the GFX 17. Further the OSD 16 is also connected to the CPU 25. This OSD 16 outputs subsidiary video information such as a caption described in the demodulated data signal Shs outputted from the DDec 15 as video information Sos to the GFX 17.

The OSD 16 outputs image data described in image information Suk in which image data with, for instance, JPEG (oint Photographic Expert Group) format outputted from the RAM 23 and the like are described as video information Sos to the GFX 17 under control by the CPU 25.

The GFX 17 is connected to the output device 30. Further the GFX 17 is also connected to the CPU 25. This GFX 17 fetches a demodulated audio signal Sei outputted from the VDec 14 under control by the CPU 25. Further the GFX 17 fetches subsidiary video information or image data described in the video information Sos outputted from the OSD 16 under control by the CPU 25. Then the GFX 17 generates superimposed video information by selectively superimposing the demodulated audio signal Sei, subsidiary video information, image data or the like according to the necessity. Then the GFX 17 outputs the superimposed video information as output information Sgm to the output device 30.

The GFX 17 generates an image with an alpha value as information indicating permeability set therein by processing the image data outputted by the OSD 16 according to the necessity under control by the CPU 25. It is to be noted that the image data with an alpha value set therein is sometimes described as virtual graphics plane. The GFX 17 superimposes a plurality of virtual graphics planes according to the necessity, and outputs the superimposed virtual graphics plane as output information Sgm to the output device 30.

The recording section 18 is connected to the HDD 22. Further the recording section 18 is also connected to the CPU 25. This recording section 18 includes a buffer 18A, and a recording processor 18B and the like. The buffer 18A temporally stores therein a TS packet outputted from the Demux 12. The recording processor 18B fetches the TS packet described in a recording signal Sdk outputted from the Demux 12 under control by the CPU 25 and stores the TS packet in the buffer 18A in the readable state according to the necessity. Then the recording processor 18B reads out the TS packet stored in the buffer 18A according to the necessity and subjects the TS packet to the prespecified processing to generate the main TS packet 43A. Then the recording processor 18B converts the main TS packet 43A to a recording signal Sre according to the necessity and outputs the recording signal Sre to the HDD 22. The processing for generating the main TS packet 43A in the recording processor 18B is described hereinafter.

The reproducing section 19 is connected to the HDD 22. The reproducing section 19 is also connected to the CPU 25. The reproducing section 19 includes a buffer 19A and a reproducing processor 19B or the like. The buffer 19A temporally stores therein the main TS packet 43A outputted from the HDD 22. The reproducing processor 19B fetches the main TS packet 43A described in a reproducing signal Spy outputted from the HDD 22 under control by the CPU 25, and stores the main TS packet 43A in the buffer 19A in the readable state according to the necessity. Then the reproducing processor 19B reads out the main TS packet 43A stored in the buffer 19A, converts the main TS packet 43A to a reproducing signal Spz according to the necessity, and outputs the reproducing signal Spz to the Demux 12 or to the HSI 21.

The reception window for remote controller 20 receives, for instance, infrared ray outputted from a remote controller not shown in the figure. Then the reception window for remote controller 20 converts a delivery signal included in the infrared ray to an operation signal Srm according to the necessity and outputs the operation signal Srm to the CPU 25.

The HSI 21 is an interface based on, for instance, IEEE (Institute of Electrical and Electronic Engineers) 1394 standard capable of high speed processing. The HSI 21 fetches, for instance, TS described in a processing signal Sci outputted from an external device not shown and provided outside the recording/reproducing device 10. The HSI 21 converts the fetched TS to a digital signal Sht according to the necessity and outputs the digital signal Sht to, for instance, the Demux 12. Further the HSI 21 fetches, for instance, the main TS packet 43A described in the reproducing signal Spz outputted, for instance, from the reproducing section 19. Then the HSI 21 converts the fetched main TS packet 43A to a processing signal Sci according to the necessity, and outputs the processing signal Sci to an external device not shown and provided outside the recording/reproducing device 10.

The HDD 22 is connected to the reproducing section 19. Further the HDD 22 is also connected to the CPU 25. This HDD 22 is controlled by an ATA (AT Attachment) interface. It is to be noted that, although the descriptions herein assume the configuration in which the HDD 22 is controlled by the ATA interface, but also the configuration is allowable in which the HDD 22 is controlled by the IDE (Integrated Drive Electronics) interface or the SCSI (Small Computer System Interface) interface or the like. Although the HDD 22 is used as a storage in the configuration described above, the present invention is not limited to this configuration. This HDD 22 stores therein a plurality of contents information 40 or the like as data information as shown in FIG. 2 in the readable state according to the necessity.

The contents information 40 is used for reproducing contents data. The contents information 40 is based on a tabular structure and includes contents additional information 41 which is a section for storing therein contents additional information, program information 42 which is a section for storing information associated with the main TS, a main TS 43 which is a section for storing therein contents data, and the like.

The program information 42 is associated with the main TS 43. This program information 42 is based on a tabular structure in which a reproducing flag 42A as flag information indicating whether the contents data has been reproduced or has not been reproduced yet, an access time 42B as a section for recording therein a date of reproduction, a thumbnail 42C as a section for storing therein a representative sill picture or the like are integrated into one data structure.

The reproducing flag 42A is, for instance, 1-byte information. This reproducing flag 42A indicates whether contents data associated with the contents information 40 has been reproduced or not. More specifically, the reproducing flag 42A of “0” indicates that the contents data was not reproduced any time in the past, and the reproducing flag 42A of “1” indicates that the contents data was reproduced at least once.

The access time 42B is, for instance, 5-byte information. This access time 42B indicates information concerning a date and time when the contents data was reproduced last. More specifically, when the reproducing flag 42A is “1”, namely when the contents data was reproduced at least once in the past, date and time information indicating the date and time when the contents data was reproduced last is described in the access time 42B. On the other hand, when the reproducing flag 42A is “0”, namely when the contents data was not reproduced any time in the past, the date and time when the contents was recorded is recorded in the access time 42B.

The thumbnail 42C is a representative still image having, for instance, the JPEG format. In this embodiment, the configuration is described in which a representative still image having the JPEG format is used as the thumbnail 42C, but the present invention is not limited to this configuration, and any format including the GIF (Graphics Interchange Format) format or the bit map format may be employed in the present invention.

The main TS 43 is data to reproduce contents configured and recorded as so-called the partial TS by selectively fetching only TSs concerning specific contents from the TS fetched by the NIM 11. This main TS 43 includes a plurality of main TS packets 43A as shown in FIG. 3. Further the main TS packet 43A is based on a tabular structure and includes a copy control flag 43B, arrival time 43C, a TS packet 43D or the like.

The copy control flag 43B is, for instance, 2-bit information. This copy control flag 43B is flag information used for controlling copying of various types of data incorporated in the TS packet 43D. With this copy control flag 43B, such information as that copying of various types of data incorporated in the TS packet 43D is inhibited, or that copying of the data is allowed unconditionally is indicated.

The arrival time 43C is, for instance, 30-bit information. This arrival time 43C is information concerning a point of time when the main TS packet 43A is stored in the HDD 22.

The TS packet 43D is, for instance, 188-bit information. This TS packet 43D is a packet in which such information as audio information, video data, data for data broadcasting, PAT (Program Association Table), PMT (Program Map Table), or SIT (Selection Information Table) is incorporated.

The contents additional information 41 relates to the contents information 40 such as a file name for the program information 42, a file name for the thumbnail 42C as image-specific information, and a file name for the main TS 43 as data-specific information.

The RAM 23 stores therein various types of data required when fetching and recording desired contents data from the TS outputted from the NIM 11 or when reproducing the recorded contents data in the readable state according to the necessity. This RAM 23 includes, as shown in FIG. 4, a program using area 23A, a PAT storage area 23B, a PMT storage area 23C, an exchange PAT storage area 23D, an exchange PMT storage area 23E, a SIT storage area 23F, and an image storage area 23G. In the following descriptions, a case is described as one of the examples in which the RAM 23 has the seven storage areas as described above, but the present invention is not limited to this configuration, and the other configurations are allowable in which the RAM 23 does not have any storage area as described above, or in which the RAM 23 has 8 or more storage areas. Further the RAM 23 may include a drive or a driver to store various types of data in a recording medium such as a HD or an optical disk in the readable state.

The program using area 23A is used to store therein various types of data required in the processing for generating or updating the contents information 40 and in the processing for deciding an alpha value for a virtual graphics plane in the readable state so that the various types of data can be read out any time according to the necessity.

The PAT storage area 23B is used to store therein a PAT incorporated in a TS packet in the processing for recording contents data in the readable state so that the PAT can be read out any time according to the necessity. Further the PAT storage area 23B is used to store therein a PAT incorporated in the main TS packet 43A in the processing for reproducing contents data in the readable state so that the PAT can be read out any time according to the necessity.

The PMT storage area 23C is used to store therein a PMT incorporated in a TS packet in the processing for recording contents data in the readable state so that the PMT can be read out any time according to the necessity. Further the PMT storage area 23C is used to store therein a PMT incorporated in the main packet 43A in the processing for reproducing the contents data in the readable state so that the PMT can be read out any time according to the necessity.

The exchange PAT storage area 23D is used to store therein a PAT to be incorporated in the main TS packet 43A in the processing for recording contents data in the readable state so that the PAT can be read out any time according to the necessity.

The exchange PMT storage area 23E is used to store a PMT to be incorporated in the main TS packet 43A in the processing for recording contents data in the readable state so that the PMT can be read out any time according to the necessity.

The SIT storage area 23F is used to store therein an SIT to be incorporated in the main TS packet 43A in the processing for recording contents data in the readable state so that the SIT can be read out any time according to the necessity.

The image storage area 23G is used to store therein image data to be incorporated as the thumbnail 42C in the program information 42 in the contents information 40 in the processing for recording contents data in the readable state so that the image can be read out any time according to the necessity.

The ROM 24 is used to store therein various programs developed on an OS (Operating System) for controlling operations of the recording/reproducing device 10 as a whole in the readable state so that the various programs can be read out any time according to the necessity. Further the configuration is allowable in which a drive or a driver is used to store data and information in a recording medium such as a HDD (Hard Disc) or an optical disc in place of the ROM 24 in the readable state.

The CPU 25 controls a recording controller 25A, a contents information generating section 25B as a date and time fetching section for storing therein a date and time for reproduction to fetch date information and time information, a thumbnail generating section 25C as an expression changing section, a reproducing controller 25D, a clock 25E, a counter 25F or the like, all of which are provided as programs, as shown in FIG. 5.

The recording controller 25A controls operations of the NIM 11, Demux 12, recording section 18 and other related sections so that desired contents data is stored in the HDD 22 in the readable state according to the necessity. More specifically, the recording controller 25A recognizes, based on an operation signal Srm received from the reception window for remote controller 20, information requesting that desired contents data is to be recorded in the HDD 22.

The contents information generating section 25B generates the contents information 40 and stores the contents information 40 in the HDD 22 in the readable state so that the contents information 40 can be read out any time according to the necessity. Further the contents information generating section 25B reads out the contents information 40 of the contents data reproduced by the reproducing controller 25D any time according to the necessity. Then the contents information generating section 25B updates the program information 42 incorporated in the contents information 40 any time according to the necessity.

The thumbnail generating section 25C determines whether the contents data was reproduced at least once in the past or not. When it is determined that the contents data was not reproduced any time in the past, the thumbnail generating section 25C generates a virtual graphics plane for displaying a thumbnail having an expression indicating that the contents data was not reproduced any time in the past. On the other hand, when it is determined that the contents data was reproduced at least once in the past, the thumbnail generating section 25C computes and recognizes the number of lapsed days indicating a time difference between the day when the contents data was reproduced last and the current date. Then the thumbnail generating section 25C generates a virtual graphics plane for displaying a thumbnail having an expression based on the recognized number of lapsed days.

The reproducing controller 25D controls operations of the Demux 12, ADec 13, VDec 14, DDec 15, GFX 17, reproducing section 19 or other related sections to output desired contents data to the output device 30.

The clock 25E recognizes a current point of time based on a reference pulse such as an internal clock.

The counter 25F counts the number of virtual graphics planes generated by the GFX 17.

There can be enlisted such devices as a personal computer, a television set, a mobile phone, a PDA (Personal Digital Assistant) or the like as examples of the output device 30. The output device 30 receives contents data inputted from the recording/reproducing device 10 and outputs the received data. The output device 30 includes an audio output section 31 and a display section 32 or the like.

The audio output section 31 has an audio generator such as a speaker not shown in the figures. This audio output section 31 outputs audio data described in the demodulated audio signal Sot received from the ADec 13 as voices and sounds from the audio generator.

The display section 32 is used to display video data for a superimposed video stream described in the output information Sgm received from the GFX 17, a virtual graphics plane, or the like thereon. Such devices as a liquid crystal or organic EL (Electro Luminescence) panel, a PDP (Plasma Display Panel), a CRT (Cathode-Ray Tube) may be used as the display section 32.

[Operations of Contents Recording/Reproducing System]

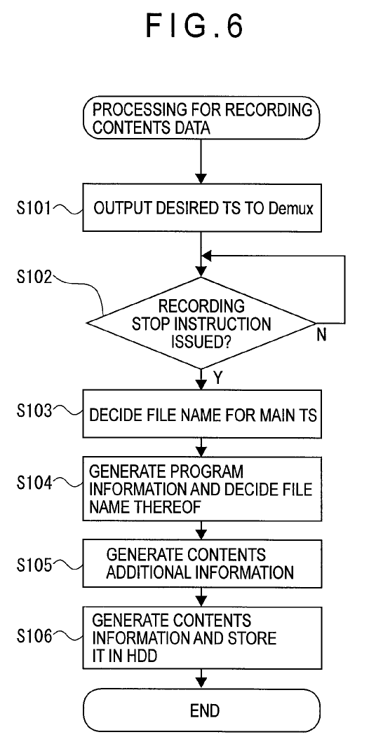

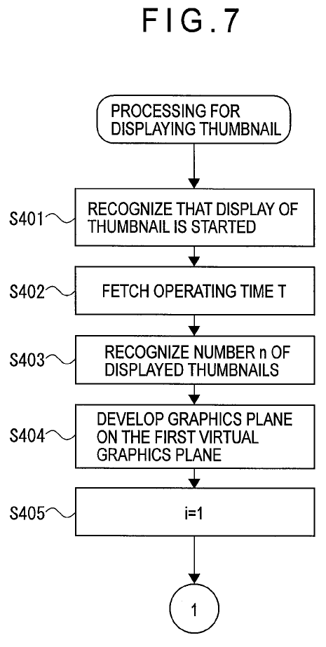

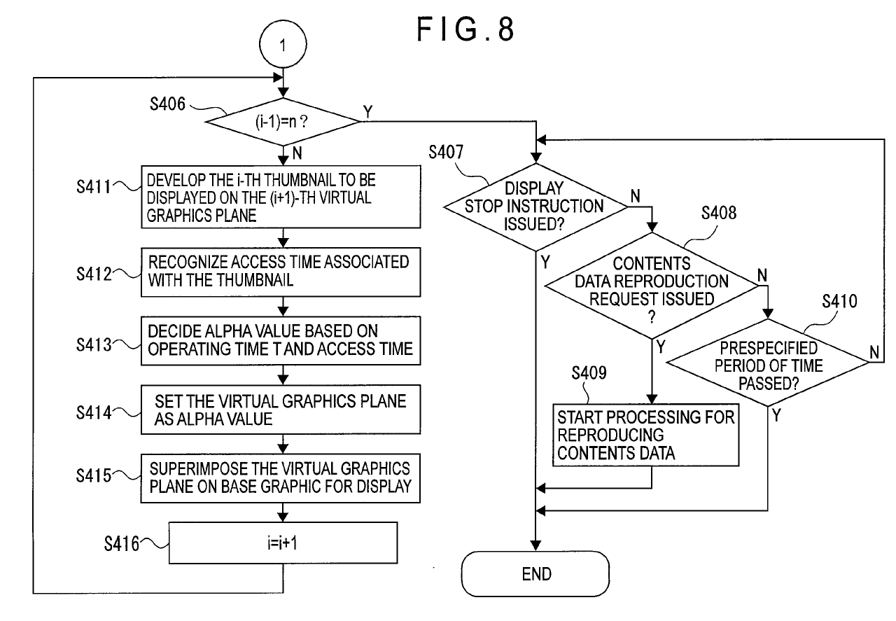

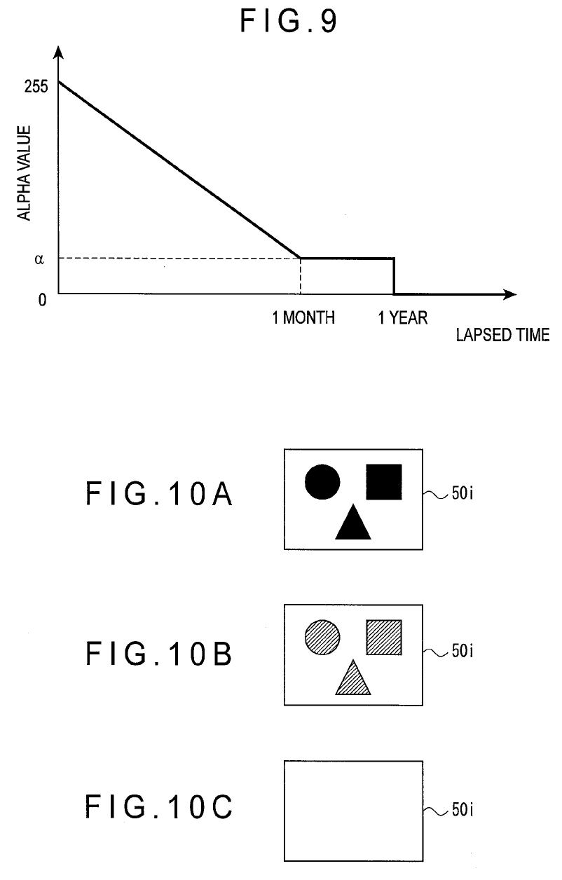

Operations of the recording/reproducing system 100 are described below with reference to the related drawings. FIG. 6 is a flow chart illustrating the processing for recording contents data. FIG. 7 and FIG. 8 are flow charts each illustrating the processing for displaying a thumbnail. FIG. 9 is a graph showing a relation between the number of lapsed days and an alpha value.

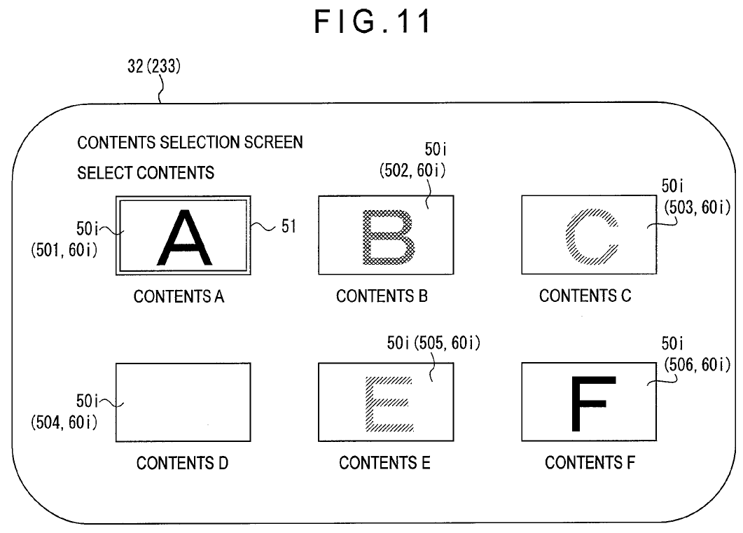

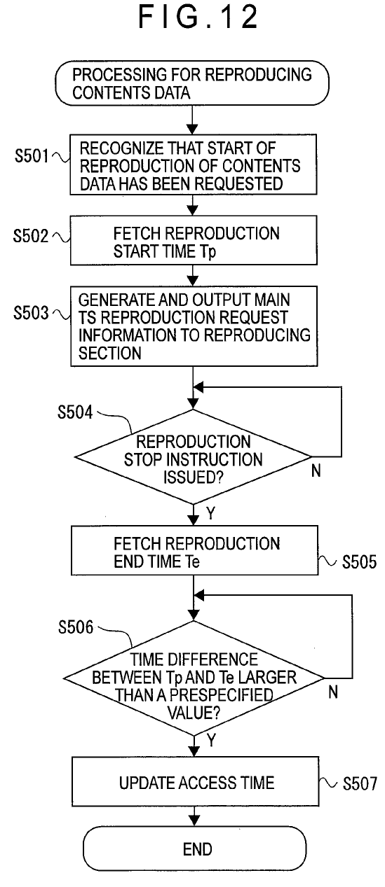

FIG. 10A to FIG. 10C are schematic views each showing a relation between a date when each contents data is reproduced and a date when a thumbnail for the contents data is to be displayed on an output device, and FIG. 10A is a schematic view illustrating a case in which contents data was reproduced on May 31, 2002 and then a thumbnail for the contents data was displayed on the same day; FIG. 10B is a schematic view showing a case in which the contents shown in FIG. 10A was not reproduced and a thumbnail for the contents data was displayed on Jun. 14, 2002; and FIG. 10C is a schematic view showing a case in which the contents data shown in FIG. 10B was not reproduced and a thumbnail for the contents data was displayed on Jun. 15, 2003. FIG. 11 is a schematic view showing thumbnails shown on the output device. FIG. 12 is a flow chart illustrating the processing for reproducing the contents data.

(Processing for Recording Contents Data)

At first, the processing for recording contents data is described with reference to FIG. 6. At first a user has contents data for recording desired contents recorded in the recording/reproducing device 10 by performing preset operations with a remote controller not shown, namely generates recording request information indicating the necessity of storage of the main TS 43 having the desired contents data in the HDD 22. This recording request information is transmitted to the recording/reproducing device 10 by making use of infrared rays.

When the recording/reproducing device 10 receives the recording request information with the recording controller 25A in the CPU 25 via the reception window for remote controller 20 as shown in FIG. 6, the recording/reproducing device 10 recognizes a frequency of the contents to be recorded and the TSID (Transport Stream Identity) based on this recording request information. Then the recording/reproducing device 10 makes the NIM 11 fetch a TS specified by the frequency and TSID recognized as described above, and the fetched TS is outputted to the Demux 12 (step S101).

The recording controller 25A determines whether recording stop instructing information requesting stop of the operation for recording the main TS 43 has been received or not (step S102). This recording stop instructing information is generated, for instance, when a user performs an operation for setting with a remote controller, and is inputted into the reception window for remote controller 20 by making use of infrared rays.

When it is determined in step S102 that the recording stop instructing information has not been received yet, the recording controller 25A fetches the current time from the clock 25E according to the necessity.

On the other hand, when it is determined in step S102 that the recording stop instructing information has been received, the recording/reproducing device 10 reads out the main TS 43 stored in the HDD 22 with the contents information generating section 25B and has the main TS 43 stored in the program using area 23A of the RAM 23. Then the recording/reproducing device 10 decides a file name for this main TS 43 (step S103).

Further the contents information generating section 25B generates flag information indicating that the contents data in the main TS 43 was not reproduced any time in the past. In addition the contents information generating section 25B fetches a representative still image stored in the image storage area 23G, and converts this representative still image to, for instance, an image having the JPEG format. Then the contents information generating section 25B generates program information 42 with the converted representative still image incorporated therein as the thumbnail 42C and has the generated flag information stored in the program using area 23A as the reproducing flag 42A. It is to be understood that a date when the recording stop instructing information is received may be recorded in the access time 42B for the program information 42 generated in this step. Then the contents information generating section 25B decides a file name for this program information 42 (step S104).

The contents information generating section 25B generates contents additional information 41 with the file name for the main TS 43 decided in step S103 and the file name for the program information 42 decided in step S104 incorporated therein (step S105). Then the contents information generating section 25B reads out the program information 42 and the main TS 43 from the program using area 23A. Then the contents information generating section 25B generates the contents information 40 with the contents additional information 41, main TS 43, and program information 42 incorporated therein, and has the contents information 40 stored in the HDD 22 (step S106) to terminate the processing for recording the contents data.

After the processing for recording the contents data is finished, when the VDec 14 fetches thumbnail generation requesting information, the VDec 14 fetches, based on this thumbnail generation request information, a representative still image by one frame from the video data incorporated in the video packet outputted from the Demux 12. Then the VDec 14 has the fetched representative still image stored in the image storage area 23G in the readable state so that the image can be read out any time according to the necessity.

(Processing for Displaying Thumbnail)

The processing for displaying a thumbnail is described below with reference to FIG. 7 to FIG, 11. At first, a user performs an operation for setting with a remote controller to generate a thumbnail display request information as a request signal for requesting display of a thumbnail for the contents data recorded in the recording/reproducing device 10 on the output device 30. Then the user transmits the thumbnail display request information to the recording/reproducing device 10 by making use of infrared rays.

When the recording/reproducing device 10 receives the thumbnail display request information via the reception window for remote controller 20 with the thumbnail generating section 25C, the recording/reproducing device 10 recognizes the request for display of a thumbnail on the output device 30 based on this thumbnail display request information (step S401). Then the thumbnail generating section 25C fetches the current date and time information including the current date from the clock 25E, and has this current date and time information as an operated date and time T indicating a date and time for display request stored in the program using area 23A (step S402). Then the thumbnail generating section 25C recognizes the number of contents information 40 stored in the HDD 22, and recognizes the number of contents information 40 recognized as described above as a number n of thumbnails to be displayed on the output device 30 (Step S403). The description above assumes a case in which a number n of thumbnails to be displayed is recognized by recognizing the number of contents information 40 stored in the HDD 22, but the present invention is not limited to this configuration, and for instance the configuration as described below may be employed. Namely information concerning a number n of contents associated with a number n of contents information 40 stored in the HDD 22 is stored in the HDD 22 in the readable state so that the information can be read out any time according to the necessity. In this case, a number n of thumbnails to be displayed is recognized by referring to this contents number information.

Then the thumbnail generating section 25C decides such parameters as an output size and an output position of the virtual graphics plane which is a thumbnail to be displayed on the output device 30 based on the number n of thumbnails recognized in step S403 according to the necessity. The thumbnail generating section 25C also controls the GFX 17 to develop base graphics with the texts such as, for instance, “Contents selection screen”, “Select contents” described therein on a first visual graphics plane (Step S404). Then the thumbnail generating section 25C sets a counter value i on the counter 25F to 1 (step S405).

Then the thumbnail generating section 25C determines, as shown in FIG. 8, whether a value obtained by subtracting 1 from the counter value i, namely (i−1) is equal to or over the number n of thumbnail to be displayed or not (step S406). When it is determined that value is equal to or over the number n, the thumbnail generating section 25C determines whether display stop instructing information has been received or not (step S407). This display stop instructing information is generated, for instance, in response to a user's operation for setting with a remote controller, and is inputted into the reception window for remote controller 20 over the infrared rays.

When it is determined in step S407 that the display stop instructing information has been received, the thumbnail generating section 25C terminates the processing for displaying the thumbnails.

On the other hand, when it is determined in step S407 that the display stop instructing information has not been received, the thumbnail generating section 25C determines whether the reproduction request information requesting reproduction of contents data has been received or not (step S408).

When it is determined in step S408 that the thumbnail generating section 25C has received the reproduction request information, the recording/reproducing device 10 starts the processing for reproducing contents data described hereinafter and shown in FIG. 12 with the reproducing controller 25D (step S409). Then the recording/reproducing device 10 terminates the processing for displaying thumbnails.

On the other hand, when it is determined in step S408 that the thumbnail generating section 25C has not received the reproduction request information, the recording/reproducing device 10 fetches the current date and time from the clock 25E, and also fetches the operated date and time T from the program using area 23A. Then the recording/reproducing device 10 determines whether a prespecified period of time, for instance, 30 minutes has passed since start of the processing for displaying thumbnails or not from the current date and time as well as the operated date and time T fetched as described above (step S410). The description above assumes a case in which the prespecified period of time is 30 minutes, but the present invention is not limited to this configuration, and the prespecified period of time may be set to, for instance, 5 minutes or one hour.

When it is determined in step S410 that the prespecified period of time has passed, the thumbnail generating section 25C terminates the processing for displaying thumbnails.

On the other hand, when it is determined in step S410 that the prespecified period of time has not passed yet, the system control returns to step S407.

When it is determined in step S406 that the counter value i is not equal to nor over the number n of thumbnails to be displayed, the thumbnail generating section 25C executes, for instance, the processing as described below. The thumbnail generating section 25C searches for the thumbnail 42C to be displayed i-th on the output device 30. As a method for searching the thumbnail 42C, there can be enlisted, for instance, a method in which search is performed according to an order of storage of the thumbnail 42C in the HDD 22. Then the thumbnail generating section 25C makes the OSD 16 fetch the thumbnail 42C previously retrieved from the HDD 22. When the thumbnail 42C is fetched, the OSD 16 subjects the thumbnail 42C to decoding and outputs the decoded thumbnail 42C to the GFX 17. When the GFX 17 receives the decoded thumbnail from the OSD 16, the GFX 17 develops, under control by the thumbnail generating section 25C, the thumbnail 42C on the (i+1)-th virtual graphics plane (step S411).

The thumbnail generating section 25C recognizes the contents information 40 with the thumbnail 42C developed on the virtual graphics plane incorporated therein in step S411. When the thumbnail generating section 25C recognizes by referring to the reproducing flag 42A for the contents information 40 that the reproducing flag 42A is “0”, namely that the contents data in the main TS 43 was not reproduced any time in the past, the thumbnail generating section 25C executes, for instance, the processing as described below. The thumbnail generating section 25C changes the preset parameter for the (i+1)-th virtual graphics plane to a value other than the alpha value, namely to a parameter for non-transparency. In this step of changing the preset parameter, for instance, the color tone is changed to the monochrome tone or to the sepia tone, but the present invention is not limited to this configuration.

On the other hand, when the thumbnail generating section 25C recognizes, by referring to the reproducing flag 42A, that the reproducing flag 42A is “1”, namely that the contents data was reproduced at least once in the past, the thumbnail generating section 25C recognizes the access time 42B of the contents information 40 (step S412). Then the thumbnail generating section 25C reads out the operated date and time T stored in the program using area 23A, and computes the time difference between the operated date and time T and the access time 42B, namely the number of lapsed days after the contents data was reproduced last. Then the thumbnail generating section 25C decides an alpha value for the (i+1)-th virtual graphics plane based on the graph as shown, for instance, in FIG. 9 and from the number of lapsed days obtained as described above (step S413).

Namely, the thumbnail generating section 25C determines the alpha value as 255 when the number of lapsed days is 0. When the number of lapsed days is one month or more but less than one year, the thumbnail generating section 25C determines the alpha value as or near 0 (zero) to provide the same display as that when the number of lapsed days is one month. Further when the number of lapsed days is one year or more, the thumbnail generating section 25C determines the alpha value as 0 (zero). When the number of lapsed days is more than one day and less than one month, the thumbnail generating section 25C determines as the alpha value smaller than that for one month in proportion to the number of lapsed days. In the above description, the alpha value is determined by referring to the graph shown in FIG. 9, but the present invention is not limited to this configuration.

Then the thumbnail generating section 25C controls the GFX 17 so that the alpha value for the (i+1)-th virtual graphics plane is set to that decided in step S413 (step S414), and also converts the virtual graphics plane to a preset output size. Then the thumbnail generating section 25C displays the (i+1)-th virtual graphics plane on the output device 30 superimposing the (i+1)-th virtual graphics plane onto the first virtual graphics plane, namely on a prespecified position on the base graphics (step S415).

As the alpha value for the (i+1)-th virtual graphics plane is set according to the graph shown in FIG. 9, an image 50i (i; natural number) as shown in each of FIG. 10A to FIG. 10C is displayed on any display area on the display section 32 of the output device 30. In the following descriptions, the image 50i with the virtual graphics plane on the output device 30 is sometimes described as thumbnail image 50i.

For instance, in a case in which contents data was reproduced on May 31, 2002 and displayed as a thumbnail on the same day, the number of lapsed days is 0 (zero), so that the alpha value is set to 255. Therefore the thumbnail image 50i displayed on the output device 30 is not transparent as shown in FIG. 10A.

When the thumbnail is displayed on Jun. 14, 2002 without reproducing the contents data, as the number of lapsed days is 14, so that the alpha value is set to a value smaller than 255. Therefore, the thumbnail image 50i is not-transparent as shown in FIG. 10B.

Further, when the thumbnail is displayed on Jun. 15, 2003 without reproducing the contents data, as the number of lapsed days is more than one year, the alpha value is set to 0 (zero). Therefore, the thumbnail image 50i is transparent as shown in FIG. 10C and can not visually be recognized.

For instance, when the contents data was reproduced on Jun. 14, 2003 by selecting the thumbnail image 50i as shown in FIG. 10C and then the thumbnail was displayed on the same day, as the number of lapsed days is 0 (zero), the alpha value is set to 255. Therefore the thumbnail image 50i is semi-transparent as the thumbnail image 50i shown in FIG. 10A.

In a case in which the contents data described above was recorded, for instance, on May 14, 2002 and the thumbnail for the contents data was displayed on May 28, 2002 without reproducing the contents data, the contents data was not reproduced any time in the past. In the case as described above, the configuration may be employed in which the thumbnail image 50i is displayed with an expression not shown herein and different from that varying in accordance with the number of lapsed days and the expression is not changed according to the number of lapsed days. Also the configuration is allowable in which, like in the case of the thumbnail image for the reproduced contents data, the expression is changed in response to the number of lapsed days from the date of recording. Whether the contents data was reproduced at least once in the past or not can be recognized by referring to the reproducing flag 42A.

After the processing in step S415 is over, the thumbnail generating section 25C increments the counter value i on the counter 25F by 1 (step S416), and then executes the processing in step S506.

The thumbnail generating section 25C further executes the processing in step S406, and in steps S411 through step S416 according to the necessity to display 6 thumbnail images 50i on the output device 30 as shown in FIG. 11. For instance, a thumbnail image 501 for the contents A to be displayed first with the second virtual graphics plane is displayed at the left top position on the screen, a thumbnail image 503 for the contents C to be displayed third with the fourth virtual graphics plane at the right top position on the screen, and a thumbnail image 505 for the contents E to be displayed fifth with the sixth virtual graphics plane at a center in the bottom side of the screen. The above description assumes the configuration in which 6 thumbnail images 50i are displayed on the output device 30, but the present invention is not limited to this configuration. Further, although the thumbnail images 50i are displayed sequentially from the left top position on the screen, but the present invention is not limited to this configuration.

It is to be noted that, in FIG. 11, the number of lapsed days for each of the contents A associated with the thumbnail image 501 and contents F associated with the thumbnail image 506 is, for instance, 0 (zero) respectively. Therefore the thumbnail image 501 and the thumbnail image 506 are displayed as opaque images. The number of days of the contents B associated with the thumbnail image 502 is, for instance, 10 days. Therefore the thumbnail image 502 is displayed as a semi-transparent image. Further the number of lapsed days for each of the contents C associated with the thumbnail image 503 and the contents E associated with the thumbnail image 505 is, for instance, 20 days longer than that of the contents B. Therefore, the thumbnail image 503 and the thumbnail image 505 are displayed as semi-transparent images having the higher transparency than that of the thumbnail image 502. The number of lapsed days of the contents D associated with the thumbnail image 504 is more than one year. Therefore the thumbnail image 504 is displayed as a transparent image and can not visually be recognized.

(Processing for Reproducing Contents Data)

The processing for reproducing contents data is described below with reference to FIG. 12. At first, a user sends reproduction request information requesting reproduction of desired contents data to the recording/reproducing device 10 by operating a remote controller. This reproduction request information is generated, for instance, as described below. At first, when a plurality of thumbnail images 50i are displayed on the output device 30 as shown in FIG. 11, the user drags a cursor 51 displayed around one of the displayed thumbnail images 50i to a position around the thumbnail image 50i for the desired contents data by operating the remote controller. Then the user presses, for instance, a decision button of the remote controller to transmit the reproduction request information to the recording/reproducing device 10 making use of infrared rays.

The recording/reproducing device 10 fetches the reproduction request information via the reception window for remote controller 20 with the reproducing controller 25D as shown in FIG. 12. Then the recording/reproducing device 10 recognizes, based on this reproduction request information, that start of reproduction of the contents data is demanded (step S501). Then the recording/reproducing device 10 fetches the current date and time including the current date from the clock 25E with the contents information generating section 25B, and has this current date and time as the current start time Tp stored in the program using area 23A (step S502).

The recording/reproducing device 10 recognizes with the reproducing controller 25D the main TS 43 having the contents data to be reproduced based on the reproduction request information, and generates main TS reproduction request information requesting reproduction of the recognized main TS 43. Then the recording/reproducing device 10 outputs the main TS reproduction request information to the reproducing section 19 (step S503) to execute the processing for reproducing the contents data. The main TS 43 to be reproduced can be recognized, for instance, with the method as described below. Namely, the reproducing controller 25D searches for the thumbnail 42C corresponding to the thumbnail image 50i surrounded by the cursor 51 from the HDD 22. Then the reproducing controller 25D recognizes the contents information 40 with the searched thumbnail 42C incorporated therein. Then the reproducing controller 25D recognizes a file name for the main TS 43 by referring to the contents additional information 41 in the recognized contents information 40 to recognize the main TS 43.

The recording/reproducing device 10 determines, after outputting the desired contents data to the output device 30, whether the reproduction stop instructing information requesting termination of reproduction of the contents data has been received or not (step S504). This reproduction stop instructing information is generated, for instance, in response to a user's operation of a remote controller for setting, and is inputted into the reception window for remote controller 20 by making use of infrared rays.

When it is determined in step S504 that the reproduction stop instructing information has not been received, the reproducing controller 25D fetches the current time from the clock 25E according to the necessity, and again executes the processing in step S504.

When it is determined in step S504 that the reproduction stop instructing information has been received, reproduction of the contents data is stopped by the reproducing controller 25D. Then the recording/reproducing device 10 fetches the current data and time from the clock 25E with the contents information generating section 25B. Then the recording/reproducing device 10 has the current date and time fetched described above as the reproduction end time Te stored in the program using area 23A (step S505).

The contents information generating section 25B reads out the reproduction start time Tp and the reproduction end time Te stored in the program using area 23A. Then the contents information generating section 25B determines whether the time difference between the reproduction start time Tp and the reproduction end time Te, namely the time for reproduction as a period of time for processing the contents data is longer than a prespecified period of time, for instance, one minute or not (step S506). The description above assumes a case in which the prespecified period of time is set to one minute, but the present invention is not limited to this configuration, and the prespecified period of time may be set to, for instance, 30 seconds or three minutes.

When it is determined by the contents information generating section 25B in step S506 that the time for reproduction is shorter than one minute, the recording/reproducing device 10 terminates the processing for reproducing the contents.

On the other hand, when it is determined in step S506 that the time for reproduction is longer than one minute, the recording/reproducing device 10 executes, for instance, the processing as described below. At first, the contents information generating section 25B searches for and reads out the contents information 40 with the main TS 43 having the output contents data incorporated therein from the HDD 22. Then the contents information generating section 25B recognizes the reproducing flag 42A for the contents information 40 read out as described above. When the reproducing flag 42A is “0”, the contents information generating section 25B generates the flag information of “1” indicating that the contents data in the main TS 43 was reproduced at least once in the past. Then the contents information generating section 25B changes the reproducing flag 42A for the contents information 40 read out as described above to the generated flag information of “1”. Then the contents information generating section 25B describes the reproduction end date in the access time 42B for this contents information 40 (step S507). On the other hand, when the reproducing flag 42A for the contents information 40 read out as described above is “1”, the contents information generating section 25B changes the access time 42B to the reproduction end date (step S507). Then the contents information generating section 25B has the contents information 40 stored in the HDD 22 and terminates the processing for reproducing the contents data.

[Advantages of First Embodiment]

In the first embodiment as described above, the recording/reproducing device 10 of the recording/reproducing system 100 fetches, when recognizing the demand indicating a reproduction stop of contents data in the reproducing controller 25D, a reproduction end date as the access time 42B of the contents data with the contents information generating section 25B. Then the recording/reproducing device 10 recognizes, when recognizing with the thumbnail generating section 25C the demand indicating a display of a thumbnail of the contents data on the output device 30, the access time 42B of the contents data. Then the thumbnail generating section 25C determines, based on the number of lapsed days from the access time 42B, an alpha value of the virtual graphics plane developed thereon the thumbnail 42C. Further the recording/reproducing device 10 controls the GFX 17 to generate a virtual graphics plane with an alpha value set to that specified as described above thereon. By outputting this virtual graphics plane to the output device 30, the recording/reproducing device 10 makes the output device 30 display the thumbnail in an expression corresponding to the access time 42B.

As described above, by setting an alpha value of a virtual graphics plane based on the lapsed days from the access time 42B, the recording/reproducing device 10 has, as shown, for instance, in FIG. 11, the output device 30 display the thumbnail image 50i having a different expression according to the number of lapsed days since the contents data has been reproduced last. With this feature, a user can easily recognize the number of lapsed days from the last reproduction of the contents data when looking at an expression of the thumbnail image 50i. Therefore preference to each contents indicated by the number of lapsed days from the last reproduction of the contents data can be easily recognized.

The thumbnail generating section 25C fetches, when recognizing the demand indicating that the thumbnail should be displayed, the operated date and time T. Then the thumbnail generating section 25C recognizes the time difference between the operated date and time T and the access time 42B as the number of lapsed days, and determines an alpha value based on the lapsed days. As described above, the alpha value is determined based on the number of lapsed days on the basis of the operated date and time T when the thumbnail generating section 25C recognizes the demand indicating that the thumbnail should be displayed, so that the number of lapsed days from the last reproduction of the contents data can be recognized more easily with an expression of the thumbnail image 50i. Therefore preference to each contents can be recognized more easily.

The recording/reproducing device 10 fetches, when recognizing the demand indicating a reproduction start of the contents data with the reproducing controller 25D, the reproduction start time Tp with the contents information generating section 25B. Further, the recording/reproducing device 10 fetches, when recognizing the demand indicating a reproduction stop of the contents data with the reproducing controller 25D, the reproduction end time Te with the contents information generating section 25B. Then the contents information generating section 25B determines whether the reproduction period of time of the contents data calculated from the reproduction start time Tp and the reproduction end time Te is equal to or over a prespecified time or not. When the contents information generating section 25B determines that the reproduction period of time is equal to or over the prespecified time, the contents information generating section 25B has the HDD 22 store therein the reproduction end date and time as the access time 42B to update the access time 42B. On the other hand, when the contents information generating section 25B determines that the reproduction period of time is not equal to nor over the prespecified time, the contents information generating section 25B does not update the access time 42B. With this configuration as described above, even when a user has reproduced the contents data which he/she did not actually want to, for instance, by an erroneous operation, if the reproduction period of time is not equal to nor over the prespecified time, the access time 42B is not to be updated. Thus the access time 42B is updated only when the contents data which a user do want to reproduce is reproduced. Therefore preference to each contents can be recognized more securely with the thumbnail image 50i changed an expression thereof based on the number of lapsed days from this access time 42B.

The thumbnail generating section 25C changes an alpha value of a virtual graphics plane, namely the degree of transparency, based on the number of lapsed days from this access time 42B. Easiness of the thumbnail image 50i in visual recognition can be thus changed by changing the degree of transparency of the virtual graphics plane. Consequently, preference to each contents can be recognized more easily and securely. Further, with a simple configuration in which only an alpha value of the virtual graphics plane is changed, the expression of the thumbnail image 50i can be changed. Therefore the processing for changing the expression of the thumbnail image 50i can be conducted more easily.

The thumbnail generating section 25C determines, after developing the thumbnail 42C on a virtual graphics plane, whether the contents data of the main TS 43 has been reproduce at least once or not. Then, when the thumbnail generating section 25C determines that the contents data has been reproduce at least once, the thumbnail generating section 25C decides an alpha value of the virtual graphics plane based on the number of lapsed days from the access time 42B. On the other hand, when the thumbnail generating section 25C determines that the contents data has not been reproduced once, the thumbnail generating section 25C changes an item to be set other than the alpha value of the virtual graphics plane, for instance, the color tone is changed to a monochrome tone. With this configuration as described above, the thumbnail of the contents data having been reproduced at least once is displayed as a thumbnail image 50i with transparency thereof changed based on the number of lapsed days from the reproduction. On the other hand, the thumbnail of the contents data not having been reproduced once is displayed as a thumbnail image 50i with a color tone thereof being monochrome. Thus the contents data not having been reproduced once can be easily recognized with an expression of the thumbnail image 50i. Further, even if, for instance, a long period of time has passed without reproducing even once the contents data having high preference, the thumbnail image 50i is displayed with a color tone thereof being monochrome regardless of the number of lapsed days, so that it is easily be recognized that the reproduction has been missed. Therefore, preference to each contents can be recognized more securely.

In the HDD 22, the reproducing flag 42A indicating whether the contents data has been reproduced at least once or not is stored associated with the thumbnail 42C. Thus the thumbnail generating section 25C can recognize, before determining an alpha value, whether the contents data has been reproduced at least once or not with a simple processing of only referring to the reproducing flag 42A. Therefore the processing for changing an expression of the thumbnail image 50i can be conducted more easily and quickly.

In the HDD 22, the contents information 40 incorporated therein the access time 42B, the thumbnail 42C and the like is stored. Thus the thumbnail generating section 25C can identify, when determining an alpha value, the contents information 40 by retrieving the thumbnail 42C, and recognize the access time 42B from this identified contents information 40. Therefore the access time 42B can be recognized easily and quickly with a simple data structure and a simple method of only retrieving the thumbnail 42C, which allows shortening the amount of the processing time for determining an alpha value.

In the recording/reproducing device 10 is provided a clock 25E. With this configuration, the reproduction start time Tp, the reproduction end time Te or the like required for, for instance, the processing for updating the access time 42B in the contents information generating section 25B can be fetched quickly according to the necessity. Thus the processing time such as the processing for updating, for instance, the access time 42B can be further shortened.

The recording/reproducing system 100 has the configuration in which the recording/reproducing device 10 and the output device 30 connected to this recording/reproducing device 10 are provided. The output device 30 fetches a virtual graphics plane generated by the GFX 17 in the recording/reproducing device 10, and displays the virtual graphics plane on the display section 32. With this feature, on the display section 32 is displayed a thumbnail image 50i. As described above, with the configuration in which the recording/reproducing system 100 has the recording/reproducing device 10 and the output device 30, it is not necessary to provide the recording/reproducing device 10 with another display section for displaying a thumbnail. Thus the configuration of the recording/reproducing device 10 can be simplified. Further a downsized and weight-saving recording/reproducing device 10 can be designed easily.

In the HDD 22 is stored the thumbnail 42C. The thumbnail generating section 25C changes an expression of a thumbnail image 50i by developing the thumbnail 42C stored in the HDD 22 on a virtual graphics plane and determining an alpha value of this virtual graphics plane according to the necessity. Thus, by storing the thumbnail 42C beforehand in the HDD 22, time for fetching the thumbnail 42C with the contents information generating section 25B can be shortened. Therefore time of the processing for changing an expression of the thumbnail image 50i can be shortened.

The contents data according to the present invention assumes video data with a series of data row structures having a plurality of different image data. The recording controller 25A controls, when having the HDD 22 store therein the main TS 43 stored therein video data, VDec 14, has this VDec 14 fetch image data from the video data inputted in the VDec 14, and has the VDec 14 store the image data in the image storage area 23G. Then the recording controller 25A has the VDec 14 store the image data stored in the image storage area 23G as the thumbnail 42C in the HDD 22. As described above, with the configuration in which the thumbnail 42C is generated from the video data inputted in the VDec 14, it is not necessary to prepare in particular the image data for displaying a thumbnail of the contents data. Thus is provided the recording/reproducing system 100 having high versatility and capable of displaying a thumbnail by only providing with video data.

The thumbnail 42C, the main TS 43, or the like are storied in the HDD 22. Thus the storage of a thumbnail and contents data in the HDD 22 capable of a random access can shorten the time required for the processing described above.

In the recording/reproducing device 10 is provided the reception window for remote controller 20. In this reception window for remote controller 20, the recording/reproducing device 10 receives each of the information generated by operations for a setting with a remote controller not shown, and carries out each of the processing based on each of the received information. With the configuration as described above, a remote control operation of the recording/reproducing device 10 becomes possible, so that it is not necessary to put a limit on an installation location for the recording/reproducing device 10. Therefore the recording/reproducing system 100 having high versatility can be provided.

[Second Embodiment]

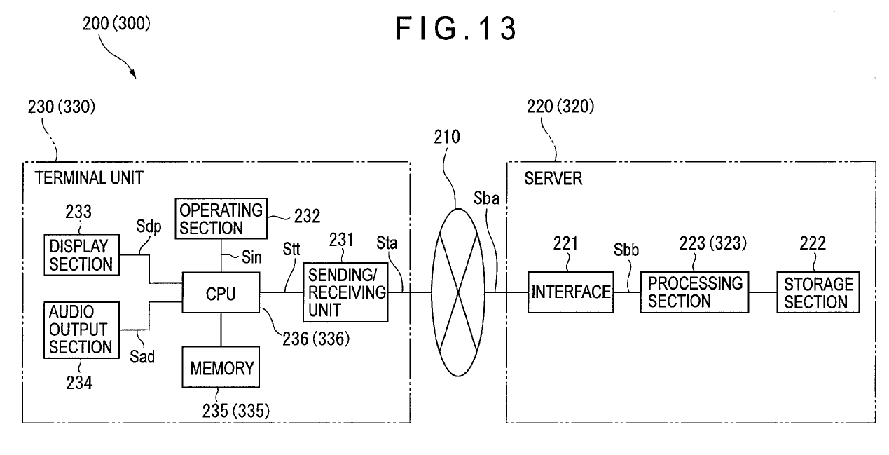

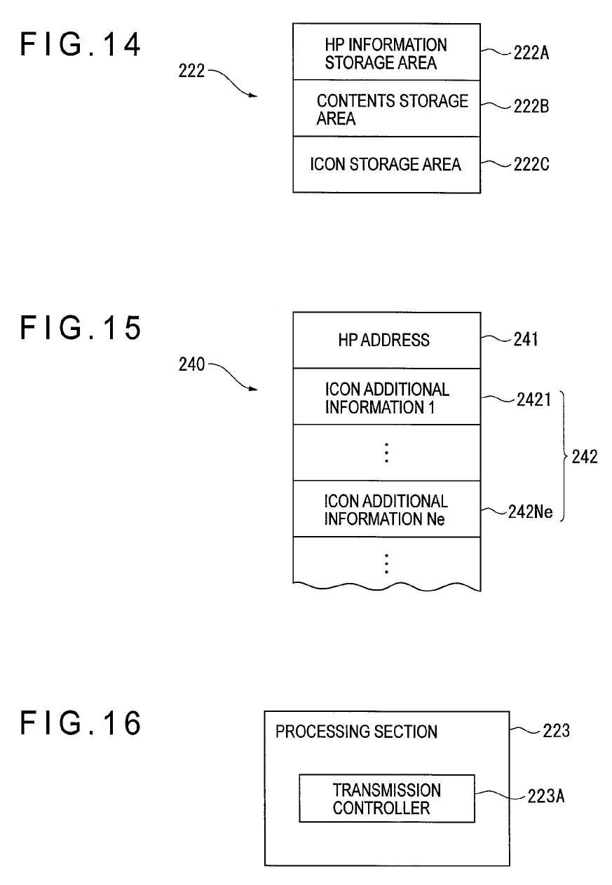

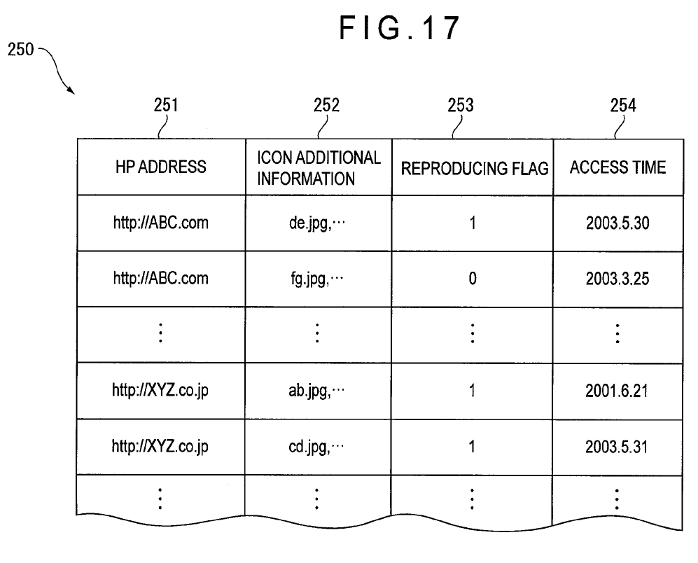

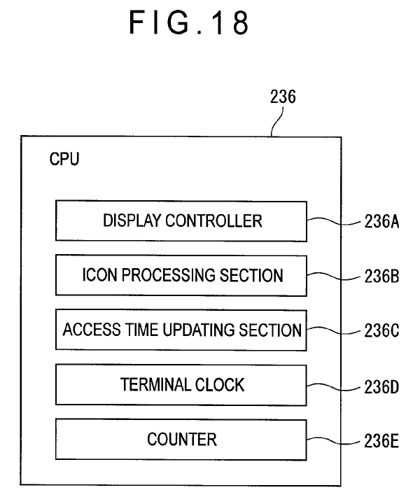

A second embodiment of the present invention is described below with reference to the related drawings. FIG. 13 is a block diagram showing general configuration of a HP (Homepage) display system in this embodiment, and the HP displaying system includes a terminal unit which is a display controller and a server which is an information storage device. FIG. 14 is a schematic view showing general configuration of a storage section in the server. FIG. 15 is a schematic view showing general configuration of HP display information stored in the storage section in the server. FIG. 16 is a block diagram showing general configuration of a processing section in the server. FIG. 17 is a schematic view showing general configuration of terminal HP information stored in a memory of the terminal unit. FIG. 18 is a block diagram showing general configuration of a CPU in the terminal unit. The same names are used for the components having the substantially same functions as those in the first embodiment, and description thereof is omitted herefrom or is simplified.

[Configuration of HP Display System]

In FIG. 13, the reference numeral 200 indicates a HP displaying system as a display control system. This HP displaying system 200 changes, based on the number of lapsed days since contents data as data for reproducing contents such as, for instance, a moving picture, stored in the server was reproduced last in the terminal unit, an expression of an icon as a representative still image associated with the contents. Then HP displaying system 200 has the icon with the changed expression on the terminal unit. This HP displaying system 200 includes a network 210, a server 220, and a terminal unit 230 as a display controller.

Connected to the network 210 are the server 220 and the terminal unit 230. The network 210 connects the server 220 and the terminal unit 230 to each other so that information can be transacted between the server 220 and the terminal unit 230. For instance, the network 210 includes, but not limited to, the Internet based on the general purpose protocol such as TCP/IP, Intranet, a LAN (Local Area Network) such as the Ethernet (Registered trademark), a network such as a communication line network or a broadcasting network in which a plurality of base stations each capable of sending and receiving information through a radio medium form a network, and further a radio medium itself which functions as a medium for direct transaction of information between the server 220 and the terminal unit 230. Any medium such as electric waves, light, sonic waves, and electromagnetic waves may be used as the radio medium.

The server 220 transmits various types of data to be displayed on the HP based on request information inputted via the network 210. The server 220 includes, as shown in FIG. 13, an interface 221, a storage section 222 as a server storage section, and a processing section 223.

The interface 221 is connected via the network 210 to the terminal unit 230, and is also connected to the processing section 223. The interface 221 can receive an information packet Sba via the network 210 from the terminal unit 230, subjects the fetched information packet Sba to the prespecified input interface processing, and outputs an information signal Sbb to the processing section 223. Further the interface 221 can receive the information signal Sbb from the processing section 223, subjects this input information signal Sbb to the prespecified output interface processing, and transmits the information signal Sbb as an information packet Sba via the network 210 to the terminal unit 230.

The storage section 222 includes, as shown in FIG. 14, a HP information storage area 222A, a contents storage area 222B, and an icon storage area 222C. The above description assumes a case in which the storage section 222 includes the three storage areas as described above, but the present invention is not limited to this configuration, and also the configuration is allowable in which any of the storage areas is not provided in the storage section 222, or in which four or more storage areas are provided in the storage section 222. Also the configuration may be employed in which a drive or a driver for storing information in a recording medium such as a HD or an optical disk in the readable state is used as the storage section 222.

The HP information storage area 222A is capable of storing therein a plurality of HP display information 240 as shown in FIG. 15 so that the information can be read out any time according to the necessity. This HP display information 240 is used to provide display of the HP. The HP display information 240 has a tabular structure in which a HP address 241, a registered icon additional information 242, and other information are complied into a set of data.

The HP address 241 is an address for the HP displayed with the HP display information 240.

The registered icon additional information 242 has a tabular structure in which a plurality of icon additional information 242Ne (Ne: natural number) is compiled into a set of data. This icon additional information 242Ne is associated with an icon displayed on a HP specified by the HP address 241. More specifically, the icon additional information 242Ne includes a file name for an icon, a display size, a display position, a file name for contents data associated with the icon.

The contents storage area 222B is capable of storing therein contents data such as video data or audio data together with a file name for the contents data in the readable state so that the data can be read out any time according to the necessity.

The icon storage area 222C is capable of storing therein an icon for the contents data stored in the contents storage area 222B together with a file name for this icon in the readable state so that the icon can be read out any time according to the necessity.

The processing section 223 is connected to the storage section 222. The processing section 223 includes the transmission controller 223A or the like as various types of programs as shown in FIG. 16.

The transmission controller 223A transmits the HP display information 240, contents data, an icon or the like according to a request from the terminal unit 230 to the terminal unit 230. It is to be noted that, when at least two of the HP display information 240, contents data, and an icon are referred to in the following descriptions, the information and data are sometimes generically described as HP data.

The terminal unit 230 includes, but not limited to, for instance, a personal computer, a television set, a mobile phone, and a PDA. This terminal unit 230 fetches HP data or the like stored in the server 220 via the network 210. Then the terminal unit 230 executes operations such as display of a HP or reproduction of contents data based on the fetched HP data. Further the terminal unit 230 subjects the icon associated with the contents data to the necessary processing to change an expression of the icon according to the necessity and display the icon with the changed expression. This terminal unit 230 includes a sending/receiving unit 231, an operating section 232, a display section 233 as a display, an audio output section 234, a memory 235 as a storage section, and a CPU 236.

The sending/receiving unit 231 is connected via the network 210 to the server 220 and also to the CPU 236. The sending/receiving unit 231 can receive an information packet Sta via the network 210 from the server 220. Further the sending/receiving unit 231 executes the preset output interface processing under control by the CPU 236 and transmits the information packet Sta via the network 210 to the server 220.

The operating section 232 is, for instance, a keyboard or a mouse, and has various types of operation buttons or the like operated for input. The input operations with this operation buttons includes, but not limited to, for instance, display of a HP, input of an execution command for reproducing contents data, operations for selecting icons associated with the contents data to be reproduced, reproduction of contents data, termination of reproduction of contents data, forwarding, and skipping. When an input operation is performed to set any item, the operating section 232 outputs an operation signal Sin to the CPU 236 so that the set item is set. The operations in the operating sections 232 are not limited to those with operation buttons, and also the configuration is allowable in which input operations are performed, for instance, with a touch panel provided on the display section 233 or with voices to input various types of set items.

The display section 233 is controlled by the CPU 236, and is capable of displaying thereon video signals Sdp such as HP data, video data, an icon, a virtual graphics plane and the like transmitted from the server 220. The data displayed on the display section 233 includes, but not limited to, for instance, in addition to the types of data described above, TV video data received by a television set not shown, video data recorded in a recording medium such as an optical disc or a magnetic disc each as an external device and read with a drive, video data from a memory, and the like. Specifically, the display section 233 may be a liquid crystal or organic EL panel, a PDP, a CRT and the like.

The audio output section 234 has an audio generator such as a speaker not shown. The audio output section 234 is controlled by the CPU 236, and an audio signal Sad such as audio data transmitted from the server 220 as voices and sounds from the audio generator. The audio generator can also output TV audio data received, for instance, by a television set, or audio data recorded in an optical disc or a magnetic disc.

The memory 235 is capable of storing therein the HP data fetched from the server 220, terminal HP information 250 as shown in FIG. 17, set items inputted from the operating section 232 in the readable state. Further the memory 235 stores therein, for instance, various types of programs developed on an OS controlling operations of the terminal unit 230 as a whole. The memory 235 may include a drive or a driver which stores information in a recording medium such as a HD or an electrophoto-magnetic disc in the readable state.

The terminal HP information 250 is generated by the display controller 236A described hereinafter, and includes information concerning HPs displayed on the terminal unit 230 in the past. This terminal HP information 250 is configured as a database based on a tabular structure in which a HP address 251, icon additional information 252, a reproducing flag 253 as flag information, access time 254 as a date for contents reproduction date and other data are compiled into a set of data information and incorporated as a record therein. In a record of this terminal HP information 250, various types of information associated with one icon are incorporated.

The HP address 251 is an address of a HP associated with various types of information incorporated in the record.

The icon additional information 252 is information associated with an icon to be displayed in an HP specified by the HP address 251. More specifically, the icon additional information 252 includes a file name for an icon as image-specific information, a display size, a display position, and a file name for contents data as data-specific information associated with the icon.

The reproducing flag 253 is flag information which is substantially identical to the reproducing flag 42A described in the first embodiment.

The access time 254 is information concerning a date on which the contents data was reproduced last.

The CPU 236 includes, various types of I/O ports not shown, a communication port to which the sending/receiving unit 231 is connected, a key entry port to which the operating section 232 is connected, a display control port to which the display section 233 is connected, an audio control port to which the audio output section 234 is connected, and a storage section port to which the memory 235 is connected. The CPU 236 includes, as various types of programs, and also as shown in FIG. 18, a display controller 236A, an icon processing section 236B as an expression changing section, an access time updating section 236C as a date and time fetching section which is storage section for storing a reproduction date and time to fetch date information and time information therefrom, a terminal clock 236D as a clock, and a counter 236E.

The display controller 236A fetches, for instance, the HP data stored in the server 220. Further the display controller 236A makes the display section 233 display the HP thereon or makes the display section 233 or the audio output section 234 reproduce the contents data.

The icon processing section 236B determines whether contents data was reproduced at least once in the past or not. When it is determined that the contents data was not reproduced any time in the past, icon processing section 236B generates a virtual graphics plane for displaying an icon having an expression indicating that the contents data was not reproduced any time in the past on the display section 233. On the other hand, when it is determined that the contents data was reproduced at least once in the past, the icon processing section 236B recognizes the number of lapsed days after the contents data was reproduced last. Then the icon processing section 236B generates a virtual graphics plane for displaying an icon having an expression based on the number of lapsed days on the display section 233. Details of the processing for generating a virtual graphics plane with the icon processing section 236B are described hereinafter.

The access time updating section 236C updates the reproducing flag 253 and the access time 254 in the terminal HP information 250 according to the necessity. Details of the processing for the reproducing flag 253 and the access time 254 are described below.

The terminal clock 236D recognizes the current time based on a reference pulse such as, for instance, an internal clock. Then the terminal clock 236D outputs the time information concerning the recognized current time according to the necessity.

The counter 236E counts the number of virtual graphics planes generated by the icon processing section 236B.

[Operations of the HP Display System]

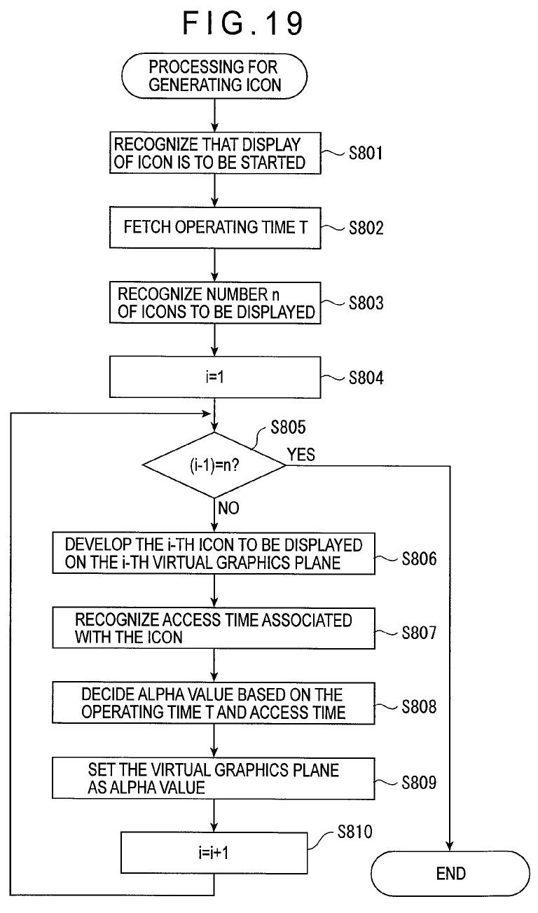

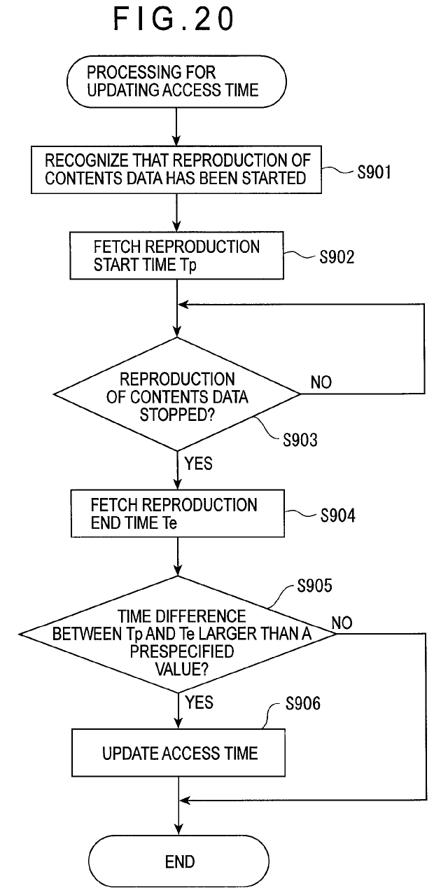

Operations of the HP displaying system 200 are described below with reference to the related drawings. The following description assumes a case in which the terminal HP information 250 associated with an HP to be displayed on the display section 233 is stored in the memory 235 of the terminal unit 230. FIG. 19 is a flow chart illustrating the processing for generating an icon. FIG. 20 is a flow chart illustrating the processing for updating the access time.

(Processing for Generating Icon)

At first, the processing for generating an icon is described with reference to FIG. 19. First, a user inputs an instruction for displaying a desired HP on the display section 233, for instance, by performing an input operation in the operating section 232.

When the display controller 236A in the CPU 236 recognizes the user=s instruction for displaying the HP on the display section 233, the terminal unit 230 generates data transmission request information. Then the display controller 236A transmits this data transmission request information via the network 210 to the server 220.

When the server 220 receives the data transmission request information from the terminal unit 230, the transmission controller 223A recognizes the HP address and information requesting transmission of the HP data based on the data transmission request information. Then the transmission controller 223A searches for and fetches the HP data from the storage section 222, and transmits the HP data via the network 210 to the terminal unit 230.

When the display controller 236A receives the HP data from the server 220, the terminal unit 230 has the received HP data stored in the memory 235 in the readable state according to the necessity. Then the display controller 236A reads out the HP display information 240 from the memory 235, and has the HP displayed on the display section 233 based on the HP display information 240 read out as described above. Then the terminal unit 230 starts the processing for generating an icon as described in FIG. 19 with the icon processing section 236B.

When the icon processing section 236B recognizes that the HP has been displayed, for instance, on the display section 233, the icon processing section 236B recognizes the necessity of starting display of the icon (step S801). Then the icon processing section 236B fetches the current time from the terminal clock 236D, and has the current date and time stored as the operated date and time T as display request date and time in the memory 235 in the readable state according to the necessity (step S802).

Then the icon processing section 236B searches for and reads out a record with the same HP address 251 as the HP address 241 incorporated in the HP display information 240 being displayed on the display section 233 incorporated therein from the terminal HP information 250 stored in the memory 235. Then the icon processing section 236B recognizes the number of records read out as described above as a number n of icons to be displayed on the HP (step S803). Then the icon processing section 236B sets the counter value i on the counter 236E to 1 (step S804).

Then the icon processing section 236B determines whether a value obtained by subtracting 1 from the counter value i, namely (i−1) has reached the number n of displayed icons or not (step S805). When it is determined that the value of (i−1) has reached the number n, the icon processing section 236B terminates the processing for generating icons. On the other hand, when it is determined in step S805 that the value of (i−1) has not reached the number n, the icon processing section 236B searches for a file name for an icon to be displayed i-th by referring to the icon additional information 252 in the read-out record. The file name can be searched, for instance, by carrying out searching according to a sequence of storage of each record in the memory 235. Then the icon processing section 236B reads out an icon corresponding to the searched file name from the memory 235. Then the icon processing section 236B develops the read-out icon on the i-th virtual graphics plane (step S806).

Then the icon processing section 236B refers to the reproducing flag 253 for the record with the file name searched in step S806 recorded therein. When it is recognized that the reproducing flag 253 is “0”, namely that the contents data was not reproduced any time in the past, the icon processing section 236B executes, for instance, the following processing. The icon processing section 236B changes the set items other than the alpha value for the i-th virtual graphics plane, namely other than the transparency. Changing of set items includes, but not limited to, changing of color tone from monotone to the sepia tone.

On the other hand, when the icon processing section 236B determines by referring to the reproducing flag 253 that the reproducing flag 253 is “1”, namely that the contents data was reproduced at least once in the past, the icon processing section 236B recognizes the access time 254 for this record (step S807). Then the icon processing section 236B reads out the operated date and time T at which the contents data was stored in the memory 235, and computes the time difference between this operated date and time T and the access time 254, namely the number of lapsed days since the contents data was reproduced last. Then the icon processing section 236B decides an alpha value for the virtual graphics plane, for instance, based on the graph shown in FIG. 9 and from the computed number of lapsed days, for instance, with monotone, described above (step S808).

Then the icon processing section 236B sets the alpha value for the virtual graphics plane as the alpha value decided in step S808 (step S809). Then the terminal unit 230 arranges and displays the virtual graphics plane at a prespecified position on the HP based on the icon additional information 252 for the record referred to in step S806 with the display controller 236A. With this operation, an image 60i having a different expression according to the number of lapsed days is displayed, for instance, as shown in FIG. 11, at a given display area of the display section 233. In the following description, the image 60i displayed on the display section 233 with the virtual graphics plane is sometimes described as icon image 60i. In this step, although not shown in the figure, the icon image 60i for the contents data not reproduced any time in the past is displayed with an expression different from that varying according to the number of lapsed days such as a monotone display, and therefore the expression is not changed according to the number of lapsed days.

Then the icon processing section 236B increments the counter value i on the counter 236E by 1 (step S810), and then executes the processing in step S805. Then the icon processing section 236B displays n pieces of icon images 60i on the display section 233, and terminates the processing for generating icons.

(Processing for Updating Access Time)

The processing for updating the access time is described with reference to FIG. 20. At first, the user has the icon image 60i displayed on the display section 233 of the terminal unit 230 by making the HP displaying system 200 execute the processing for generating an icon as described above. Then the user selects the icon image 60i displayed on the display section 233 and associated with desired contents data to input an instruction indicating start of reproduction of the contents data by an input operation with, for instance, the operating section 232.

When it is recognized by the display controller 236A that reproduction of the contents data is to be started (step S901), the terminal unit 230 searches for and reads out the contents data from the memory 235. Then the terminal unit 230 outputs the contents data read out as described above to the display section 233 or to the audio output section 234 to start reproduction. Then the terminal unit 230 fetches the current date and time from the terminal clock 236D with the access time updating section 236C, and stores the current date and time as reproduction start date and time Tp in the memory 235 in the readable state (step S902).

The terminal unit 230 determines with the access time updating section 236C whether reproduction stop request information requesting termination of reproduction of the contents data has been received or not (step S903). The reproduction stop request information is input and set in response to an input operation, for instance, by the user in the operating section 232.

When it is determined in step S903 that the reproduction stop request information has not been received yet, the access time updating section 236C again executes the processing in step S903.

On the other hand, when it is determined by the access time updating section 236C that the reproduction stop request information has been received, the terminal unit 230 terminates reproduction of the contents data with the display controller 236A. Then the terminal unit 230 fetches the current date and time with the access time updating section 236C from the terminal clock 236D and stores the current date and time as reproduction end time Te in the memory 235 in the readable state so that the data can be read out any time according to the necessity (step S904). Then the terminal unit 230 reads out the reproduction start date and time Tp and the reproduction end date and time Te from the memory 235, and determines the time difference, namely whether the reproduction period of time as a period of time required for reproducing the contents data is longer than a prespecified period of time such as, for instance, 1 minute or not (step S905). In the descriptions above, a case is assumed in which the prespecified period of time is set to 1 minute, but the present invention is not limited to this configuration, and the prespecified period of time may be set to 30 seconds or 3 minutes.

When it is determined by the access time updating section 236C in step S905 that the reproduction period of time is shorter than 1 minute, the access time updating section 236C terminates the processing for updating the access time.

On the other hand, when it is determined in step S905 that the reproduction is longer than 1 minute, the access time updating section 236C executes, for instance, the processing as described below. At first the access time updating section 236C searches for and reads out a record with the icon additional information 252 associated with the reproduced contents data incorporated therein from the terminal HP information 250 stored in the memory 235. Then the access time updating section 236C reads out the reproducing flag 253 for the record read out as described above. When the reproducing flag 253 is “0”, the access time updating section 236C generates the flag information of “1” indicating that the contents was reproduced at least once in the past. Then the access time updating section 236C changes the reproducing flag 253 for the read-out record to the generated flag information of “1”. Then the access time updating section 236C describes the reproduction end date and time in the access time 254. On the other hand, when the reproducing flag 253 for the read-out record is “1”, the access time updating section 236C changes the access time 254 to the reproduction end date and time (step S906). Then the access time updating section 236C incorporates the record in the terminal HP information 250 stored in the memory 235 and terminates the processing for updating the access time.

[Advantages of Second Embodiment]

In the second embodiment as described above, the terminal unit 230 of the HP displaying system 200 fetches, when recognizing the request indicating a reproduction stop of contents data in the access time updating section 236C, a reproduction end time Te as the access time 254 of the contents data. Then terminal unit 230 recognizes, when recognizing with the icon processing section 236B the request indicating a display of an icon of the contents data on the display section 233, the access time 254 of the contents data. Then the icon processing section 236B determines, based on the number of lapsed days from the access time 254, an alpha value of the virtual graphics plane developed thereon the icon. Further the icon processing section 236B generates a virtual graphics plane with an alpha value set to that specified as described above thereon. By outputting this virtual graphics plane to the display section 233, the icon processing section 236B has the display section 233 display the icon in an expression corresponding to the access time 254.

As described above, by setting an alpha value of a virtual graphics plane based on the lapsed days from the access time 254, the terminal unit 230 has, as shown, for instance, in FIG. 11, the display section 233 display an icon image 60i having a different expression according to the number of lapsed days since the contents data has been reproduced last. With this feature, a user can easily recognize the number of lapsed days from the last reproduction of the contents data when looking at an expression of the icon image 60i. Therefore preference to each contents indicated by the number of lapsed days from the last reproduction of the contents data can be easily recognized.

The icon processing section 236B fetches, when recognizing the request indicating that an icon should be displayed, the operated date and time T. Then the icon processing section 236B recognizes the time difference between the operated date and time T and the access time 254 as the number of lapsed days, and determines an alpha value based on the lapsed days. As described above, the alpha value is determined based on the number of lapsed days on the basis of the operated date and time T when the icon processing section 236B recognizes the request indicating that the icon should be displayed, so that the number of lapsed days from the last reproduction of the contents data can be recognized more easily with an expression of the icon image 60i. Therefore preference to each contents can be recognized more easily.

The terminal unit 230 fetches, when recognizing the request indicating a reproduction start of the contents data with the display controller 236A, the reproduction start time Tp with the access time updating section 236C. Further, the terminal unit 230 fetches, when recognizing the request indicating a reproduction stop of the contents data with the access time updating section 236C, the reproduction end time Te. Then the access time updating section 236C determines whether the reproduction period of time of the contents data calculated from the reproduction start time Tp and the reproduction end time Te is equal to or over a prespecified time or not. When the access time updating section 236C determines that the reproduction period of time is equal to or over the prespecified time, the access time updating section 236C has the reproduction end date stored in the memory 235 as the access time 254 to update the access time 254. On the other hand, when the access time updating section 236C determines that the reproduction period of time is not equal to nor over the prespecified time, the access time updating section 236C does not update the access time 254. With this configuration as described above, even when a user has reproduced the contents data which he/she did not actually want to, for instance, by an erroneous operation, if the reproduction period of time is not equal to nor over the prespecified time, the access time 254 is not to be updated. Thus the access time 254 is updated only when the contents data which a user does want to reproduce is reproduced. Therefore preference to each contents can be recognized more securely with the icon image 60i changed an expression thereof based on the number of lapsed days from this access time 254.

The icon processing section 236B changes an alpha value of a virtual graphics plane, namely the degree of transparency, based on the number of lapsed days from the access time 254. Easiness of the icon image 60i in visual recognition can be thus changed by changing the degree of transparency of the virtual graphics plane. Consequently, preference to each contents can be recognized more easily and securely. Further, with a simple configuration in which only an alpha value of the virtual graphics plane is changed, the expression of the icon image 60i can be changed. Therefore the processing for changing the expression of the icon image 60i can be conducted more easily.

The icon processing section 236B determines, after developing an icon on a virtual graphics plane, whether the contents data has been reproduced at least once or not. Then, when the icon processing section 236B determines that the contents data has been reproduce at least once, the icon processing section 236B decides an alpha value of the virtual graphics plane based on the number of lapsed days from the access time 254. On the other hand, when the icon processing section 236B determines that the contents data has not been reproduced once, the icon processing section 236B changes an item to be set other than the alpha value of the virtual graphics plane, for instance, the color tone is changed to a monochrome tone. With this configuration as described above, the icon of the contents data having been reproduced at least once is displayed as an icon image 60i with transparency thereof changed based on the number of lapsed days from the reproduction. On the other hand, the icon of the contents data not having been reproduced once is displayed as, for instance, the icon image 60i with a monochrome tone. Thus the contents data not having been reproduced once can be easily recognized with the expression of the icon image 60i. Further, even if, for instance, a long period of time has passed without being reproduced once the contents data having high preference, the icon image 60i is displayed with a color tone thereof being monochrome regardless of the number of lapsed days, so that it is easily be recognized that the reproduction has been missed. Therefore, preference to each contents can be recognized more securely.

In the memory 235, the reproducing flag 253 indicating whether the contents data has been reproduced at least once or not is stored. Thus the icon processing section 236B can recognize, before determining an alpha value, whether the contents data has been reproduced at least once or not with a simple processing of only referring to the reproducing flag 253. Therefore the processing for changing an expression of the icon image 60i can be conducted more easily and quickly.

In the memory 235, the terminal HP information 250 incorporated therein the icon additional information 252 with a file name of an icon described therein, and the access time 254 of the contents or the like as one record is stored. Thus the icon processing section 236B can identify, when determining an alpha value, the record by retrieving a file name of the icon, and recognize the access time 254 from this identified record. Therefore the access time 254 can be recognized easily and quickly with a simple data structure and a simple method of only retrieving the file name of the icon, which allows shortening of the processing time for determining an alpha value.

In the terminal unit 230 is provided the terminal clock 236D. With this configuration, the reproduction start time Tp, the reproduction end time Te or the like required for, for instance, the processing for updating the access time 254 in the access time updating section 236C can be fetched quickly according to the necessity. Thus the processing time such as the processing for updating, for instance, the access time 254 can be further shortened.

The HP displaying system 200 has the configuration in which the server 220 and the terminal unit 230 connected to this server 220 via the network 210 are provided. In the server 220 are provided the storage section 222 for storing the contents data and the transmission controller 223A for transmitting the contents data stored in this storage section 222 to the terminal unit 230 according to the necessity. Further, in the terminal unit 230 is provided the display controller 236A for fetching the contents data from the server 220 according to the necessity and reproducing the contents data on the display section 233. As described above, with the configuration in which the contents data is fetched from the server 220 according to the necessity, it is not necessary to constantly store the contents data in the memory 235. Therefore, the capacity of the memory 235 can be reduced. Further, with the configuration in which the contents data is stored in the storage section 222 of the server 220, the same contents data can be transmitted to a plurality of the terminal units 230 according to the necessity. Therefore the HP displaying system 200 capable of sharing contents data and having high versatility can be provided.

In the server 220 are provided the storage section 222 for storing an icon and the transmission controller 223A for transmitting the icon stored in this storage section 222 to the terminal unit 230 according to the necessity. Further, in the terminal unit 230 are provided the display controller 236A for fetching an icon from the server 220 and the icon processing section 236B for changing the expression of the icon fetched in this display controller 236A. As described above, with the configuration in which an icon is fetched from the server 220 according to the necessity, it is not necessary to constantly store icons in the memory 235. Thus the capacity of the memory 235 can be reduced. Further, with the configuration in which icons are stored in the storage section 222 of the server 220, the same icons can be transmitted to a plurality of the terminal units 230 according to the necessity. Therefore the HP displaying system 200 capable of sharing icons and having high versatility can be provided.

The terminal unit 230 is provided with the icon processing section 236B, the access time updating section 236C or the like, and has the configuration in which processing for generating an icon and for updating access time are executed in the terminal unit 230. Therefore the configuration of the server 220 can be simplified. Further, the HP displaying system 200 capable of reducing the loading for processing of the server 220 and capable of sending and receiving the HP data more quickly can be provided.

[Third Embodiment]

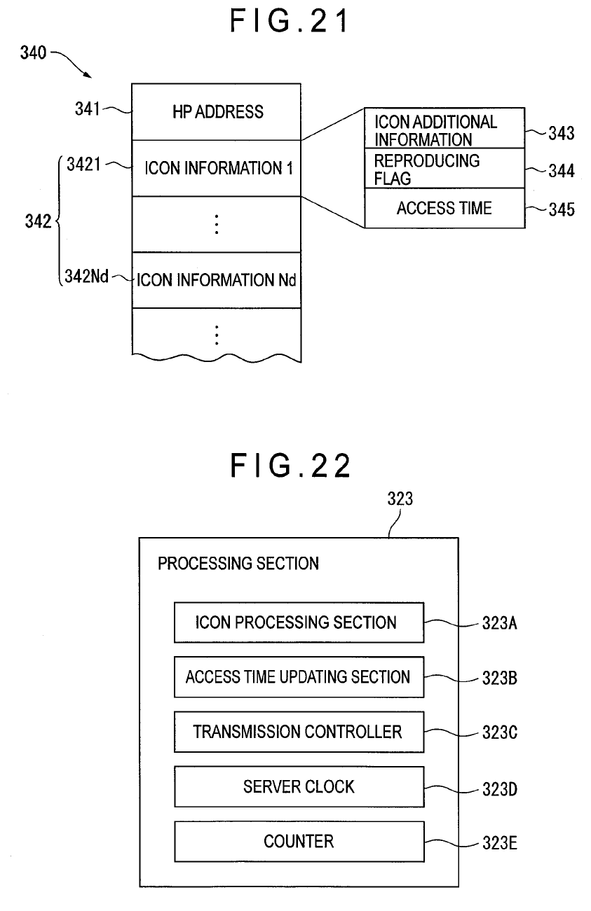

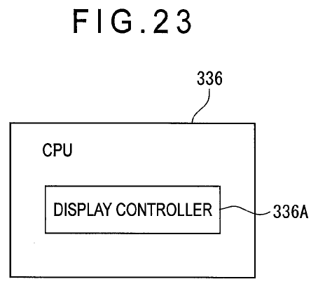

Next a third embodiment of the present invention is described with reference to the related drawings. FIG. 21 is a schematic view showing general configuration of the HP display information stored in a storage section of a server which is an information storage device according to the preset embodiment. FIG. 22 is a block diagram showing general configuration of a processing section in the server. FIG. 23 is a block diagram showing general configuration of a CPU of a terminal unit which is a display controller. The same reference numerals are assigned to the same components as those in the second embodiment and detailed description thereof is omitted herefrom. Also the name is used for a component having the same function as that in the second embodiment and detailed description thereof is omitted herefrom.

[Configuration of HP Display System]

In FIG. 13, the reference numeral 300 indicates a HP displaying system as a display control system. This HP displaying system 300 changes, based on the number of elapsed days since contents data as data stored in the server is reproduced last, an expression of an icon as a representative sill picture associated with the contents data. The HP displaying system 300 further transmits the icon with the changed expression to a terminal unit to be displayed thereon. This HP displaying system 300 includes a network 210, a server 320 as a display controller, and a terminal unit 330.

The server 320 transmits HP data for displaying a HP to the terminal unit 330 based on request information inputted via the network 210. The server 320 includes an interface 221, a storage section 222 as a storage section for a controller, a processing section 323, and the like.

The interface 221 is connected via the network 210 to the terminal unit 330, and is also connected to the processing section 323.

The storage section 222 includes a HP information storage area 222A, a contents storage area 222B, an icon storage area 222C, and a program using area not shown.

The HP information storage area 222A in the storage section 222 is capable of storing therein a plurality of the HP display information 340 as a plurality of data information as shown in FIG. 21 in the readable state so that the HP display information 340 can be read out anytime according to the necessity. The HP display information 340 is used for displaying a HP. The HP display information 340 is based on a tabular structure, in which an HP address 341, registered icon information 342, and other types of data are compiled into a set of data.

The registered icon information 342 has a tabular structure in which a plurality of icon information 342Nd (Nd: natural number) is compiled into a set of data. The icon information 342Nd is information associated with an icon displayed on a HP specified by the HP address 341. Further the icon information 342Nd has a tabular structure in which the icon additional information 343, reproducing flag 344 as flag information, access time 345 as a data and time for reproduction of contents data and the like are compiled into a set of data.

The icon additional information 343 is information associated with an icon specified by the icon information 342Nd. More specifically, the icon additional information 343 is information such as a file name for an icon as image-specific information, a display size, a display position, and a file name for contents data as data-specified information associated with the icon.

The reproducing flag 344 is flag information which is substantially the same as the reproducing flag 253 in the second embodiment.

The access time 345 is information which is substantially the same as the access time 254 in the second embodiment.

The program using area is capable of storing therein various types of data required for the processing for generating an icon or the processing for updating the access time so that the data can be read out any time according to the necessity.

The processing section 323 includes, as shown in FIG. 22, various programs such as an icon processing section 323A as an expression changing section, an access time updating section 323B as a date and time fetching section which is storage section for storing a reproduction date and time, a transmission controller 323C which also functions as an expression changing section, a server clock 323D as a clock, and a counter 323E.

The icon processing section 323A determines whether contents data was reproduced at least once in the past in the terminal unit 330 or not. When it is determined that the contents was not reproduced any time in the past, the icon processing section 323A generates a virtual graphics plane for displaying an icon having an expression indicating that the contents data was not reproduced any time in the past on the display section 233. On the other hand, when it is determined that the contents was reproduced at least once in the past, the icon processing section 323A recognizes the number of days since the contents data was reproduced last. Then the icon processing section 323A generates a virtual graphics plane for displaying an icon having an expression based on the number of lapsed days on the display section 233 of the terminal unit 330. Details of the processing for generating the virtual graphics plane with the icon processing section 323A are described hereinafter.

The access time updating section 323B updates the reproducing flag 344 for the HP display information 340 and the access time 345 according to the necessity. Details of the processing for updating the reproducing flag 344 and the access time 345 are described hereinafter.

The transmission controller 323C transmits, based on a request from the terminal unit 330, HP data such as the HP display information 340, contents data, and a virtual graphics plane to the terminal unit 330. More specifically, based on an information signal Sbb inputted from the interface 221, the transmission controller 323C recognizes data transmission request information also functioning as request information described in this information signal Sbb. Then, based on this data transmission request information, the transmission controller 323C recognizes the HP address and information requesting transmission of HP data. Then the transmission controller 323C fetches the HP display information 340 with the same HP address 341 as the recognized HP address incorporated therein, contents data associated with the HP display information 340, and a virtual graphics plane generated by the icon processing section 323A. Then the transmission controller 323C converts the HP data fetched as described above to the information signal Sbb and outputs the information signal Sbb to the interface 221 according to the necessity.

The server clock 323D recognizes the current data and time based on a reference pulse such as an internal clock. Then the server clock 323D outputs the date and time information concerning the recognized current date and time according to the necessity.

The counter 323E counts the number of virtual graphics planes generated by the icon processing section 323A.

The terminal unit 330 fetches HP data or the like stored in the server 320 via the network 210. Then the terminal unit 330, for instance, displays a HP or an icon based on the HP data fetched as described above or reproduces the contents data. This terminal unit 330 includes an sending/receiving unit 231, an operating section 232, a display section 233 as a display device, an audio output section 234, a memory 335, and a CPU 336.

The memory 335 stores therein the HP data fetched from the server 320, set items inputted in the operating section 232, and the like in the readable state so that the data and the items can be read out any time according to the necessity. Further the memory 335 stores therein various programs or the like developed on an OS which controls operations of the terminal unit 330 as a whole.

The CPU 336 includes various programs as shown in FIG. 23 such as the display controller 336A as an image display controller also functioning as a notified information generating section as a program.

The display controller 336A fetches the HP data and the like stored in the server 320. Then the display controller 336A has the HP displayed on the display section 233 or the contents data reproduced on the display section 233 or the audio output section 234. More specifically, the display controller 336A recognizes, based on an operating signal Sin inputted, for instance, from the operating section 232, information requesting display of the HP on the display section 233 described in this operating signal Sin. Then the display controller 336A generates data transmission request signal, converts this data transmission request information to an information signal Stt, and transmits the information signal Stt to the sending/receiving unit 231. Then the display controller 336A fetches the HP data described in this information signal Stt or the like based on the information signal Stt inputted from the sending/receiving unit 231. Then the display controller 336A converts the fetched HP data to a memory signal Sme according to the necessity and stores the memory signal Sme in the memory 335 in the readable state so that the data can be read out any time according to the necessity. Then the display controller 336A reads out the HP display information 340 and the virtual graphics plane stored in the memory 335 as a memory signal Sme according to the necessity, converts the HP display information 340 and the virtual graphics plane to a processing signal Sdp and outputs the processing signal Sdp to the display section 233 according to the necessity.

When the display controller 336A recognizes, based on the operating signal Sin inputted from time to time from the operating section 232, that the contents data described in this operating signal Sin is to be reproduced, executes, for instance, the following processing. At first the display controller 336A retrieves the icon information 342Nd associated with the contents data from the HP display information 340 stored in the memory 335. Then the display controller 336A recognizes a file name for the contents data by referring to the icon additional information 343 in this retrieved icon information 342Nd. Then the display controller 336A searches for and reads out the contents data having the recognized file name as a memory signal Sme from the memory 335. Then the display controller 336A converts the contents data to a video signal Sdp or an audio signal Sad according to the necessity, and outputs the video signal or the audio signal to display section 233 or to the audio output section 234. Then the display controller 336A generates reproduction start notification information notifying that reproduction of the contents data has been started. Then the display controller 336A outputs the reproduction start notification information generated as described above to the information signal Stt and outputs the information signal Stt to the sending/receiving unit 231.

When the display controller 336A recognizes, based on the operating signal Sin inputted from time to time from the operating section 232, that reproduction of the contents data descried in this operating signal Sin is to be stopped, the display controller 336A executes, for instance, the following processing. At first, the display controller 336A stops output of the video signal Sdp or audio signal Sad with the contents data described therein to the display section 233 or to the audio output section 234. Then the display controller 336A recognizes the contents data, reproduction of which has been stopped, and searches for and reads out the icon information 342Nd associated with the contents data recognized as described above from the memory 335. Then the display controller 336A generates, together with the icon information 342Nd read out as described above, reproduction stop notification information as processing notification information for notifying that reproduction of the contents data has been stopped. Then the display controller 336A converts the reproduction stop notification information to the information signal Stt and outputs the information signal Stt to the sending/receiving unit 231 according to the necessity.

[Operations of HP Display System]

Operations of the HP displaying system 300 are described with reference to FIG. 19 and FIG. 20.

(Processing for Generating Icon)

At first, the processing for generating an icon is described with reference to FIG. 19. At first, a user inputs an instruction for displaying a desired HP on the display section 233 by performing an input operation in the operating section 232.

When the terminal unit 330 recognizes an instruction for displaying the HP on the display section 233 with the display controller 336A of the CPU 336, the terminal unit 330 generates data transmission request information. Then the terminal unit 330 transmits this data transmission request information via the network 210 to the server 320.

When the server 320 receives the data transmission request information from the terminal unit 330, the server 320 recognizes the HP address and the information requesting transmission of the HP data with the transmission controller 323C based on the data transmission request information. Then the server 320 recognizes with the icon processing section 323A that the terminal unit 330 starts display of an icon (step S801). Then the server 320 fetches the current date and time with the icon processing section 323A from the server clock 323D, and has the current data and time as an operated date and time T stored in the program using area of the storage section 222 in the readable state so that the data can be read out any time according to the necessity (step S802).

Then the icon processing section 323A searches for and reads out the HP display information 340 with the same HP address 341 as the HP address recognized as described above incorporated therein from the HP information storage area 222A. Then the icon processing section 323A has the read-out HP display information 340 stored in the program using area in the readable state so that the data can be read out any time according to the necessity. Then the icon processing section 323A recognizes the number of icon information 342Nd incorporated in the HP display information 340 stored in the program using area as a number n of icons to be displayed on the HP (step S803). Then the icon processing section 323A sets the counter value i on the counter 323E tol (step S804).

Then the icon processing section 323A determines whether a value obtained by subtracting 1 from the counter value i, namely the (i−1) value is equal to or over the number of n to be displayed or not (step S805). When it is determined that the value is equal to or over the number n of displayed icons, the icon processing section 323A terminates the processing for generating an icon. On the other hand, when it is determined that the value has not reached the number n of icons to be displayed, icon processing section 323A searches for a file name for the icon to be displayed i-th by referring to the icon additional information 343 incorporated in the icon information 342Nd in the HP display information 340 stored in the program using area. The file name can be searched, for instance, by searching it according to a sequence of storage of the icon information 342Nd for instance in the storage section 222. Then the icon processing section 323A reads out an icon having the file name searched as described above from the icon storage area 222C. Then the icon processing section 323A develops the icon read out as described above on the i-th virtual graphics plane (step S806).

Then the icon processing section 323A refers to the reproducing flag 344 for the icon information 324Nd with the file name for the icon searched in step S806 described therein. When it is recognized that the reproducing flag 344 is “0”, namely that the contents data was not reproduced any time in the past, the icon processing section 323A executes, for instance, the following processing. The icon processing section 323A changes the setting for items other than an alpha value, namely the items other than the transparency for the (i+1)-th virtual graphics plane. The changing of the set items includes, for instance, changing of the color tone from the monotone to sepia tone, but the present invention is not limited to this configuration.

On the other hand, when the icon processing section 323A refers to the reproducing flag 344 and recognizes that the reproducing flag 344 is “1”, namely that the contents data was reproduced at least once in the past, the icon processing section 323A recognizes the access time 345 for this icon information 342Nd (step S807). Then the icon processing section 323A reads out the operated date and time T, and computes the time difference between this operated date and time T and the access time 345, namely the number of lapsed days since the contents data was reproduced last. Then the icon processing section 323A decides an alpha value for the vertical graphics plane, based on the graph shown in FIG. 9, from the computed number of lapsed days (step S808).

Then the icon processing section 323A sets an alpha value for the virtual graphics plane to the value decided in step S808 (step S809). Then the icon processing section 323A increments the counter value i on the counter 323E by 1 (step S810), and then executes the processing in step S805. Then the icon processing section 323A generates n pieces of virtual graphics planes and then terminates the processing for generating icons.

The server 320 recognizes a file name for contents data by referring to the icon additional information 343 in the HP display information 340 stored in the program using area. Then the transmission controller 323C searches for the contents data having the recognized file name and fetches the contents data from the contents storage area 222B. Then the transmission controller 323C transmits the contents data together with the HP display information 340 stored in the program using area and the virtual graphics planes generated in the icon processing section 323A to the terminal unit 330.

When the display controller 336A receives the HP data from the server 320, the terminal unit 330 has the received HP data stored in the memory 335 in the readable state so that the data can be read out any time according to the necessity. Then the terminal unit 330 reads out the HP display information 340 and the virtual graphics planes from the memory 335. Further the terminal unit 330 has the HP displayed on the display section 233 based on the HP display information 340 read out as described above. Further the terminal unit 330 allocates and displays the virtual graphics planes at prespecified positions on the HP based on the icon additional information 343 in the HP display information 340. With this operation, the icon images 60i each having a different expression according to the number of lapsed days are displayed, for instance, as shown in FIG. 11. The icon image 60i for contents data not having been reproduced any time in the past is shown, for instance, with monotone different from an expression varying according to the number of lapsed days although not shown herein, and the expression is not changed according to the number of lapsed days.

(Processing for Updating Access Time)

The processing for updating access time is described with reference to FIG. 20. At first, a user makes the HP displaying system 300 execute the processing for generating icons to have the icon images 60i displayed on the display section 233 of the terminal unit 330. Then the user inputs an instruction for starting reproduction of contents data by selecting the icon images 60i associated with the desired contents data displayed on the display section 233, for instance, by performing input operations in the operating section 232.

When the display controller 336A recognizes the instruction for starting reproduction of the contents data, the terminal unit 330 executes, for instance, the following processing. At first, the display controller 336A searches for and reads out the contents data from the memory 335. Then the display controller 336A outputs the contents data read out as described above to the display section 233 or to the audio output section 234 to start reproduction of the contents data. Then the display controller 336A generates reproduction start notification information, and transmits the reproduction start notification information via the network 210 to the server 320.

On the other hand, when the access time updating section 323B receives the reproduction start notification information, the server 320 recognizes based on this reproduction start notification information that the terminal unit 330 has started reproduction of the contents data (step S901). Then the access time updating section 323B fetches the current date and time from the server clock 323D, and has the current data and time stored as reproduction start time Tp in the program using area in the readable state so that the data can be read out any time according to the necessity (step S902).

When an instruction for stopping reproduction of the contents data is inputted, for instance, in response to the user's input operation in the operating section 232, the terminal unit 330 recognizes the instruction for stopping reproduction of the contents data with the display controller 236A. Then the display controller 236A terminates reproduction of the contents data. Then the display controller 236A generates reproduction stop notification information, and transmits the reproduction stop notification information via the network 210 to the server 320.

At a prespecified point of time, for instance, in one minute after the processing in step S902 is executed, the server 320 determines with the access time updating section 323B whether the reproduction stop notification information has been received from the terminal unit 330 or not (step S903). In the above description, the prespecified point of time is set to one minute after the processing in step S902 is executed, the present invention is not limited to this configuration, and the prespecified point of time may be set to 30 seconds or three minutes after the processing in step S902 is executed.

When it is determined in step S903 that the reproduction stop notification information has not been received yet, the access time updating section 323B again executes the processing in step S903.

On the other hand, when it is determined that the reproduction stop request information has been received, the access time updating section 323B fetches the current time from the server clock 323D, and has this current time stored as reproduction end time Te in the program using area in the readable state so that the data can be read out any time according to the necessity (step S904). Then the access time updating section 323B reads out the reproduction start time Tp and the reproduction end time Te from the memory 235, and determines whether the time difference between the reproduction start time Tp and the reproduction end time Te, namely the time for reproduction as a data processing period for the contents data is longer than a prespecified period of time, for instance, one minute or not (step S905). Although the above description assumes a case in which the prespecified period of time is set to one minute, the present invention is not limited to this configuration, and the prespecified period of time may be set, for instance, to 30 seconds or three minutes.

When it is determined in step S905 that the time for reproduction is shorter than one minute, the access time updating section 323B terminates the processing for updating access time.

On the other hand, when it s determined that the time for reproduction is longer than one minute, the access time updating section 323B executes, for instance, the following processing. At first, the access time updating section 323B recognizes the icon information 342Nd described in the reproduction stop notification information. Then the access time updating section 323B searches for and reads out the HP display information 340 with the same the icon information 342Nd as the recognized icon information 342Nd incorporated therein from the HP information storage area 222A. Then the access time updating section 323B has the read-out HP display information 340 stored in the program using area in the readable state so that the information can be read out any time according to the necessity. Then the access time updating section 323B reads out the reproducing flag 344 for the icon information 342Nd from the HP display information 340 stored in the program using area. When it is determined that the reproducing flag 344 read out as described above is “0”, the access time updating section 323B generates the flag information of “1” indicating that the contents data was reproduced at least once in the past. Then the access time updating section 323B reads out the HP display information 340 from the program using area, and changes the reproducing flag 344 for the HP display information 340 to the flag information of “1” generated as described above. Then the access time updating section 323B describes the reproduction end date and time in the access time 345. When it is determined that the reproducing flag 344 is “1”, the access time updating section 323B changes the access time 345 for the HP display information 340 to the reproduced end date and time (step S906). Then the access time updating section 323B has the HP display information 340 stored in the storage section 222 and terminates the processing for updating access time.

[Advantages of Third Embodiment]

With the third embodiment as described above, the server 320 in the HP displaying system 300 fetches the reproduction stop notification information with the access time updating section 323B to recognize that reproduction of contents data has been stopped. Then the server 320 fetches the reproduction end time Te as access time 345 for the contents data. When the icon processing section 323A recognizes the request that an icon or icons for the contents data are to be displayed on the display section 233 of the terminal unit 330, the server 320 recognizes the access time 345 for the contents data. Then the icon processing section 323A decides an alpha value for the virtual graphics plane with the icon developed thereon according to the number of elapsed days from the access time 345. Then the access time updating section 323B generates the virtual graphics plane with the alpha value having been set to the decided value. Then the access time updating section 323B transmits the virtual graphics plane to the terminal unit 330 to have the icon displayed on the display section 233 of the terminal unit 330 with an expression corresponding to the access time 345.

As described above, the server 320 has the icon images 60i each having a different expression according to the number of lapsed days since the contents data is reproduced last as shown, for instance, in FIG. 11 on the display section 233 of the terminal unit 330 by setting an alpha value for the virtual graphics plane according to the number of elapsed days from the access time 345. Because of this feature, a user can easily recognize the number of lapsed days after the contents data is reproduced last from the expression of the icon image 60i. Therefore the user can easily recognize the user=s taste for contents data each indicating the number of lapsed days since the contents data is reproduced last.

When the icon processing section 323A recognizes a request for display of an icon, the icon processing section 323A fetches the operated date and time T. Then the icon processing section 323A recognizes the time difference between the operated date and time T and the access time 345 as lapsed days, and decides an alpha value according to the number of lapsed days. As described above, an alpha value is decided according to the number of lapsed days based on the operated date and time T when the request for display of the icon is recognized as a reference, so that a user can easily recognize the number of days after the contents data is reproduced last from an expression of the icon image 60i. Because of this feature, a user can easily recognize the user's taste for contents.

When the access time updating section 323B recognizes that reproduction of contents data has been started, the server 320 fetches the reproduction start time Tp. When the access time updating section 323B recognizes that reproduction of contents data has been stopped, the server 320 fetches the reproduction end time Te. Then the access time updating section 323B determines whether the time for reproduction of the contents data computed from the reproduction start time Tp as well as from the reproduction end time Te is equal to or longer than a prespecified period of time. When it is determined that the time for reproduction is equal to or longer than the prespecified period of time, the access time updating section 323B updates the access time 345 by storing the reproduction end date as the access time 345 in the storage section 222. On the other hand, when it is determined that the time for reproduction is not longer than the prespecified period of time, the access time updating section 323B does not update the access time 345. With the configuration as described above, even in a case in which, for instance, a user reproduces by mistake the contents data which the user does not intend to reproduce, if the time for reproduction is not longer than the prespecified period of time, the access time 345 is not updated. Because of this feature, only the contents data that the user wants to reproduce is updated when reproduced. Therefore, by checking each icon image 60i having an expression changing according to the number of lapsed days from the access time 345, a user can easily and correctly recognize the user's taste for contents data.

The icon processing section 323A changes an alpha value for a virtual graphics plane, namely the transparency according to the number of lapsed days from the access time 345. As described above, easiness in visual recognition of the icon image 60i can be changed by changing the transparency of the virtual graphics plane. Because of this feature, a user can easily and correctly recognize the user's taste for contents data. Further, with the simple configuration in which only an alpha value for the virtual graphics plane is changed, an expression of the icon image 60i can be changed. Therefore, the processing for changing an expression of the icon image 60i can easily and quickly be changed.

After the icon is developed on the virtual graphics plane, the icon processing section 323A determines whether the contents data was reproduced at least once in the past or not. Then, when it is determined that the contents data was reproduced at least once in the past, the icon processing section 323A decides an alpha value for the virtual graphics plane according to the number of lapsed days since the access time 345. On the other hand, when it is determined that the contents data was not reproduced any time in the past, the icon processing section 323A changes set items other than the alpha value for the virtual graphics plane, and, for instance, changes the color tone to the monotone.

With the configuration as described above, an icon for the contents data which was reproduced at least once in the past is displayed as the icon image 60i having the transparency having been changed according to the number of lapsed days after reproduction. On the other hand, an icon for contents data not having been reproduced any time in the past is displayed, for instance, as the monotone icon image 60i. Because of this feature, the contents data which was not reproduced any time in the past can easily be recognized by checking an expression of the icon image 60i. Further, even if contents data, to which a user has intense taste, is left for a long period of time without reproducing the data any time, as the icon image 60i is displayed with monotone, and therefore the fact that the contents data has not been reproduced for a long period of time can easily be noticed. Therefore a user can recognize the user=s taste for contents data more correctly.

The reproducing flag 344 indicating whether contents data was reproduced at least once in the past or not is stored in the storage section 222. Because of this feature, the icon processing section 323A can recognize whether contents data was reproduced at least once in the past or not, before deciding an alpha value, only with the simple operation of referring to the reproducing flag 344. Therefore also the icon processing section 323A can quickly execute the processing for changing an expression of the icon image 60i.

The icon information 342Nd, in which the icon additional information 343 with a file name for icons described therein, access time 345 for contents data and the like are compiled into a set of data, is stored in the storage section 222. Because of this feature, the icon processing section 323A can identify the icon information 342Nd, when deciding an alpha value, by searching for a file name for the icon, and can recognize the access time 345 from this icon information 342Nd. Therefore, the icon processing section 323A can easily and quickly recognize the access time 345 based on a simple data structure and also with the simple method of searching for a file name of the icon, and can shorten the time required for deciding the alpha value.

The server 320 has the server clock 323D provided therein. With the configuration as described above, the reproduction start time Tp or reproduction end time Te required for updating the access time 345 in the access time updating section 323B can quickly be fetched any time. Because of this feature, the processing time required, for instance, in the processing for updating the access time 345 can be shortened. Further the terminal unit 330 can fetch the HP data having been subjected to processing based on the reference date and time counted by the server clock 323D. Because of this feature, the time reliability of the icon image 60i displayed on the display section 233 of the terminal unit 330 can be improved. In addition, user=s taste for contents data can be recognized more correctly.

The HP displaying system 300 includes the server 320 and the terminal unit 330 connected via the network 210 to the server 320. The server 320 includes the storage section 222 for storing therein contents data and the transmission controller 323C for transmitting the contents data stored in the storage section 222 to the terminal unit 330 according to the necessity. Further the terminal unit 330 includes the display controller 336A for fetching contents data from the server 320 and reproducing the contents data on the display section 233. As described above, with the configuration in which contents data can be fetched from the server 320 according to the necessity, it is not necessary to always stores contents data in the memory 235. Because of this feature, a capacity of the memory 235 can be reduced. Further contents data is stored in the storage section 222 of the server 320, the same contents data can be transmitted to a plurality of terminal units 330 according to the necessity. Because of this feature, it is possible to provide the HP displaying system 300 with high versatility enabling sharing of contents data.

Icons are stored in the storage section 222 of the server 320. In addition, the icon processing section 323A develops the icon stored in the storage section 222 on a virtual graphics plane, and sets an alpha value for the virtual graphics plane according to the necessity. Then the server 320 transmits the virtual graphics plane having a fixed alpha value with the transmission controller 323C to the terminal unit 330. When the display controller 336A receives the virtual graphics plane, the terminal unit 330 has the icon image 60i displayed on the display section 233 with this virtual graphics plane. As described above, by previously storing an icon or icons in the storage section 222 of the server 320, the time required for the icon processing section 323A to fetch the icon(s) can be shortened. Therefore the processing for generating icons can be shortened. Further icons are stored in the storage section 222 of the server 320, the same icon can be transmitted to a plurality of terminal units 330 according to the necessity. Because of this feature, it is possible to provide the HP displaying system 300 with high versatility enabling sharing of contents data. In addition, a virtual graphics plane is fetched from the server 320 with the display controller 336A of the terminal unit 330 according to the necessity. Because of this feature, it is not necessary to always store icons in the memory 235 of the terminal unit 330. Therefore a capacity of the memory 235 can be reduced.

The server 320 has the icon processing section 323A, access time updating section 323B and the like provided therein, so that the processing for generating icon(s) and the processing for updating access time can be executed in the server 320 itself. Because of this feature, configuration of the terminal unit 330 can be simplified. Further the HP data having been subjected to the same processing in the icon processing section 323A or in the access time updating section 323B can be provided to a plurality of terminal units 330. Therefore it is possible to provide the HP displaying system 300 with high versatility and capable of displaying the icon image 60i with high reliability can be provided to the display sections 233 of a plurality of terminal units 330.

[Other Embodiments]

The present invention is not limited to the embodiments described above, and the modifications and variants as described below are also within the range in which the objects of the present invention can be achieved.

Namely, although the descriptions of the embodiments above assume the configuration in which the reproduction end date is set as the access time 42B, 254, 345 according to the necessity, but the present invention is not limited to this configuration, and for instance the configuration as described below may be employed. Namely the configuration is also allowable in which the reproduction start date or an arbitrary date and time during reproduction of contents data is set as the access time 42B, 254, 345 according to the necessity. With the configuration as described above, the advantages like those provided in each of the embodiments described above can be provided.

Descriptions of each of the embodiments described above assume the configuration in which determination as to whether the access time 42B, 254, 345 is to be updated or not is made based on the time for reproduction of contents data computed from the reproduction start time Tp as well as from the reproduction end time Te, but the present invention is not limited to this configuration, and for instance, the configuration as described below may be employed. Namely the configuration is allowable in which the access time 42B, 254, 345 is updated each time contents data is updated. With the configuration as described above, for instance, when the reproduction end time Te is set as access time 42B, 254, 345 according to the necessity, the processing for fetching the reproduction start time Tp, namely the operation in step S502 in the first embodiment, and the operation in step S902 in the second and third embodiments may be omitted. When the reproduction start time Tp is set as the access time 42B, 254, 345 according to the necessity, the processing for fetching the reproduction end time Te, namely the operation in step S505 in the first embodiment, and the processing in step S904 in the second and third embodiments may be omitted. Because of this feature, the time required in the processing for updating the access time 42B, 254, 345 can be shortened.

Descriptions of the embodiments above assume the configuration in which determination as to whether contents data was reproduced at least once in the past is performed by referring to the reproducing flag 42A, 253, 344, but the present invention is not limited to this configuration, and for instance the following configuration may be employed in the present invention. Namely the configuration is allowable in which determination as to whether contents data was reproduced at least once in the past is performed by checking whether the information is described in the access time 42B, 254, 345 or not. With the configuration as described above, it is not necessary to store the reproducing flag 42A, 253, 344 in the HDD 22 nor in the memory 235, 335, so that capacities of the HDD 22 and memory 235, 335 can be reduced.

Descriptions of the embodiments above assume the configuration in which an alpha value for a virtual graphics plane, namely transparency of the thumbnail image 50i or the icon image 60i is changed by referring to the number of lapsed days from the access time 42B, 254, 345, but the present invention is not limited to this configuration, and for instance the following configuration is allowable. Namely the configuration may be employed, for instance, in which the tone is changed to sepia tone or monotone based on the access time 42B, 254, 345, in which such parameters as the display size or brightness are changed, in which gradation is performed, or in which thumbnails or icons satisfying certain conditions blink. With the configuration as described above, a user can easily recognize the number of days lapsed since the contents was reproduced last from an expression of the thumbnail 50i or the icon image 60i, and the user can easily recognize the user's taste to the contents.

Descriptions of the embodiments above assumes the configuration in which an alpha value for a virtual graphics plane is decided based on the graph shown in FIG. 9, but the present invention is not limited to this configuration, and for instance the following configuration may be employed.

Namely the configuration may be employed in which the alpha value is set to a higher value as the number of lapsed days becomes larger. With the configuration as described above, for instance the thumbnail image 50i for contents data having a larger number of lapsed days is shown as an image without transparency, and for instance the thumbnail image 50i for contents data having a smaller number of lapsed days is shown as a semi-transparent image. Because of the feature as described above, contents data not having been reproduced for a long period of time can easily be recognized from an expression of the thumbnail image 50i for the contents data.

Further the configuration may be employed in which the alpha value is changed step by step according to the number of lapsed days, namely in which the alpha value is set to 255 when the number of lapsed days is shorter than one month, to 200 when the number of lapsed days is equal to or over one month and shorter than two months, and to 150 when the number of lapsed days is equal to or over two months and shorter than three months. With the configuration as described above, the number of threshold values for deciding an alpha value can be reduced, and an alpha value can be decided more easily.

Further the configuration may be employed in which a change rate of an alpha value is varied according to the number of lapsed days, namely in which, for instance, the change rate is set to a smaller value when the number of lapsed days is shorter than one month, and to a larger value when the number of lapsed days is equal to or over one month. With the configuration as described above, a change rate per day of an expression of the thumbnail image 50i when the number of lapsed days is shorter than one month is different from that when the number of lapsed days is equal to or over one month. Because of the feature, whether the number of lapsed days of contents data is more than a prespecified number of lapsed days or not can easily be recognized from a daily expression of the thumbnail image 50i.

Further the configuration may be employed in which an alpha value is set to a lower value as the number of lapsed days is larger when the number of lapsed days is shorter than a prespecified period of time, for instance, one month, and is set to a larger value as the number of lapsed days is longer than the number of lapsed days equal to or over one month. With the configuration as described above, the thumbnail image 50i become gradually more transparent when the number of lapsed days is shorter than one month, and becomes more and more opaque when the number of lapsed days is equal to or over one month. Because of the feature, whether the number of lapsed days has surpassed a prespecified period of time or more can easily be recognized from changes of an expression of the thumbnail image 50i.

Descriptions of the first embodiment assume the configuration in which the access time 42B is recognized by searching for the thumbnail 42C when deciding an alpha value, but the present invention is not limited to this configuration, and for instance the following configuration may be employed. Namely the configuration may be employed in which the access time 42B is recognized by searching for a file name for the program information 42, a file name for the thumbnail 42C, a file name for the main TS 43, and the like. With the configuration as described above, the access time 42B can easily and quickly be recognized with the simple method based on a simple data structure in which only any of a file name for the program information 42, a file name for the thumbnail 42C, and a file name for the main TS43 is checked, so that the processing for deciding an alpha value can be simplified.

Descriptions of the second and third embodiments assume the configuration in which the access time 254, 345 is recognized by searching a file name for an icon when deciding an alpha value, but the present invention is not limited to this configuration, and for instance the following configuration may be employed. Namely the configuration may be employed in which the access time 254, 345 is recognized, for instance, by searching for a file name for contents data. With the configuration as described above, the access time 254, 345 can easily and quickly be recognized with the simple method based on a simple data structure in which only a file name for contents data is checked, so that the processing for deciding an alpha value can be simplified.

In the first embodiment, the configuration may be employed, for instance, in which a keyword associated with contents data or the like is described in the contents additional information 41 in the contents information 40. With the configuration as described above, the recording/reproducing device 10 can identify, for instance, a plurality of contents information 40 by searching for a keyword or the like inputted in response to an input operation by a user. With this configuration, only the thumbnail image 50i for the contents data reproduced with specified contents information 40 can be displayed on the output device 30. Because of this feature, it is possible to provide the recording/reproducing system 100 with high versatility capable of displaying only the thumbnails 50i to which a user has strongly hope to see.

Descriptions of the embodiments above assume the configuration in which the thumbnail 42C stored in the HDD 22 or icons stored in the storage section 222 are subjected to specific processing so that the thumbnails images 50i or the icon images 60i are displayed with different expressions respectively, but the present invention is not limited to this configuration, and for instance the following configuration may be employed. Namely in the first embodiment, for instance, when it is determined in step S406 that the (i−1) value has not reached the number n of thumbnails to be displayed, the thumbnail generating section 25C fetches a portion of video data incorporated in the main TS 43 as a representative still image for the image data. The representative still image for image data fetched as described above may be subjected to necessary processing. Further in the second and third embodiments, when it is determined in step S805 that the (i−1) value has not reached the number n of icons to be displayed, the icon processing section 236B, 323A fetches a portion of the contents data stored in the storage section 222 as a representative still image for image data. Then the representative still image fetched as described above may be subjected to necessary processing. With the configuration as described above, it is not necessary to always store thumbnails 42C in the HDD 22 nor to store icons in the storage section 222, so that capacities of the HDD 22 and the storage section 222 can be reduced.

Descriptions of the first embodiment assume the configuration in which a portion of the video data incorporated in the main TS 43 stored in the HDD 22 is fetched as image data and the image data fetched as described above is stored as thumbnail 42C in the HDD 22, but the present invention is not limited to this configuration, and for instance the following configuration may be employed. Namely, a reproducing device not shown and also functioning as a server capable of outputting video data for contents such as a moving picture recorded in a recording medium such as a HD or a DVD (Digital Versatile Disc) is connected to the HSI 21 of the recording/reproducing system 100 via a network or a fiber channel similar to, for instance, the network 210 in the second embodiment. Then a portion of video data outputted from this reproducing device is fetched as image data, and the image data fetched as described above is stored as the thumbnail 42C in the HDD 22. With the configuration as described above, it is not necessary to always store video data such as the main TS43 for reproducing contents in the HDD 22, so that a capacity of the HDD 22 can be reduced. Further it is possible to provide the recording/reproducing system 100 with high versatility capable of displaying the thumbnail image 50i for desired contents by exchanging a DVD with another one according to the necessity.

Further in the configuration having the reproducing device as described above, when image data for a thumbnail or thumbnails are previously recorded in a DVD, for instance the following configuration may be employed. Namely, for instance, the configuration is allowable in which, when the thumbnail image 50i is to be displayed, the thumbnail generating section 25C fetches image data for thumbnails outputted from the reproducing device and subjects the image data fetched as described above to necessary processing. With the configuration as described above, it is not necessary to always store the thumbnail 42C in the HDD 22, so that a capacity of the HDD 22 can be reduced. Further it is possible to provide the recording/reproducing system 100 with high versatility capable of displaying the thumbnail image 50i for desired contents by exchanging a DVD with another one according to the necessity.

Further also the following configuration may be employed. Namely, in the first embodiment, the configuration is allowable in which a thumbnail generating device not shown and also functioning as a display controller including a date and time fetching section and an expression changing section is connected via a network like the network 210 in the second embodiment or a fiber channel to the HSI 21 of the recording/reproducing device 10. With the configuration as described above, the recording/reproducing device 10 outputs the thumbnails 42C stored in the HDD 22 to the thumbnail generating device according to the necessity. The thumbnail generating device develops the thumbnails 42C on a virtual graphics plane with the date and time fetching section or with the expression changing section, and sets, for instance, an alpha value for this virtual graphics plane. Then the thumbnail generating device outputs this virtual graphics plane to the recording/reproducing device 10. Then the recording/reproducing device 10 outputs the virtual graphics plane to the output device 30 to have the thumbnail image 50i on the display section 32 of the output device 30. Because of this feature, the recording/reproducing device 10 can also be used as the terminal unit according to the present invention, and versatility of the recording/reproducing device 10 is improved.

Descriptions of the second embodiment assume the configuration in which the icon fetched with the display controller 236A from the server 220 is subjected to necessary processing by the icon processing section 236B in the processing for generating an icon, but the present invention is not limited to this configuration, and for instance, the following configuration may be employed. Namely the icon fetched from the server 220 is stored in the memory 235 of the terminal unit 230. Then, when the icon is subjected to necessary processing on a day different from the day on which the icon is fetched, the icon stored in the memory 235 is fetched and subjected to the necessary processing. With the configuration as described above, it is not necessary to fetch an icon from the server 220 each time the icon is subjected to any processing. Because of this feature, the time until an icon is fetched by the icon processing section 236B can be shortened, and the time required for generating an icon can be shortened.

Descriptions of the second embodiment assume the configuration in which the terminal clock 236D is provided in the terminal unit 230, but the present invention is not limited to this configuration, and for instance, the following configuration may be employed. Namely in this configuration, a clock is provided in the sever 220. Then, when it is necessary, for instance, to update access time with the access time updating section 236C, the reproduction start time Tp or the reproduction end time Te is fetched from the clock in the server 220. With the configuration as described above, it is not necessary to provide the terminal clock 236D in the terminal unit 230. Because of this feature, configuration of the terminal unit 230 can be simplified. Further the terminal unit 230 can execute the processing for updating access time or the processing for generating an icon based on a reference date and time counted by the clock in the server 220. Because of this feature, the time reliability of the icon image 60i displayed on the display section 233 can be improved.

Descriptions of the third embodiment assume the configuration in which the server clock 323D is provided in the server 320, but the present invention is not limited to this configuration, and for instance, the following configuration may be employed. Namely in this configuration, a clock is provided in the terminal unit 330. When it is necessary, for instance, to execute the processing for updating access time with the access time updating section 323B in the server 320, the reproduction start time Tp or the reproduction end time Te are fetched from the clock in the terminal unit 330. With the configuration as described above, it is not necessary to provide the server clock 323D in the server 320. Because of this feature, configuration of the server 320 can be simplified. Further it is possible to provide the HP displaying system 300 capable of reducing a workload to the server 320 and quickly sending and receiving HP data.

Descriptions of the first embodiment assume the configuration in which, after the thumbnail image 50i is displayed in step S410, the processing for displaying the thumbnail is terminated when a prespecified number of lapsed days is over, but the present invention is not limited to this configuration, and for instance, the following configuration may be employed. Namely when it is determined in step S408 that reproduction request information has not been received yet, system control returns to step S402. Then the operations from step S402 to step S408, and also the operations in step S411 and step S416 are repeated until the reproduction request information is received in step S408.

With the configuration as described above, an expression of the thumbnail image 50i can gradually be changed until the display stop instruction information is received in step S407 or the reproduction request information is received in step S408. In this configuration, as the number of lapsed days is larger, an alpha value is set to a higher value, and when the number of lapsed days is longer than a prespecified period of time, the alpha value is set to a constant value, so that the thumbnail image 50i having a small number of lapsed days to which a user has intense taste is displayed or a semi-transparent or transparent image, and the thumbnail image 50i having a large number of lapsed days to which the user does not have intense taste is displayed as an opaque image. Then, when each thumbnail image 50i is displayed for a long period of time, the thumbnail image 50i for contents to which the user has intense taste becomes gradually more and more opaque, and the thumbnail image 50i for contents to which the user has not so intense taste is left opaque. As described above, when each thumbnail image 50i is displayed for a long time, by gradually changing an expression of the thumbnail image to which the user has intense taste, the user can easily recognize the contents to which the user has intense taste.

Further with this configuration, for instance, after the processing in step S402 is performed first, an alpha value is set according to the graph shown in FIG. 9, and the user recognizes the thumbnail image 50i with the alpha value not more than a prespecified value, namely to which the user does not have so intense taste. Then, after the processing in step S402 is executed second or more, the alpha value for the thumbnail image 50i having the alpha value not more than a prespecified value is set to a higher value as the number of lapsed days is larger as described above. With the configuration as described above, when the thumbnail image 50i is displayed first, the thumbnail image 50i for contents to which the user has intense taste is displayed as an opaque image as shown in FIG. 11, and the thumbnail image 50i for contents to which the user does not have so intense taste is displayed as a semi-transparent or transparent image. Then, when the thumbnail image 50i is kept displayed for a long period of time, the thumbnail image 50i for contents to which the user has intense taste is kept opaque, but the thumbnail image 50i for contents to which the user does not have so intense taste is gradually changed to a more and more opaque image. As described above, with the configuration in which only an expression of the thumbnail image 50i to which the user does not have so intense taste is changed when the thumbnail image 50i is kept displayed for a long period of time, the user can easily recognize the contents to which the user does not have so intense taste.

A function for subscribing reproduction of contents data may be provided in the recording/reproducing device 10 according to the first embodiment of the present invention. In this configuration, an expression of the thumbnail image 50i for contents data may be changed to that indicating that reproduction thereof has been subscribed. With the configuration as described above, contents with reproduction thereof having been subscribed to which the user has intense taste can easily be recognized.

Descriptions of the embodiments of the present invention described above assume the configuration in which data is video data such as a television program or a moving picture, but the present invention is not limited to this configuration, and also the configuration is allowable in which the data is, for instance, a representative still image, audio data for music, program data for executing a specific processing, an application software, and signal data from various devices. Also with the configuration as described above, the advantages like those in the embodiments described above can be provided.

Description of the first embodiment above assumes the configuration in which each information is generated by setting with a remote controller, but the present invention is not limited to this configuration, and for instance, the configuration is allowable in which an input section not shown is provided in the recording/reproducing device 10 and each information is generated by operating this input section. With the configuration as described above, even when a remote controller is lost, desired information can be generated by operating the input section.

Descriptions of the embodiments above assume the configuration in which the data structure of each information stored in the HDD 22, storage section 222, memory 235, 335 is as described above, but the present invention is not limited to this configuration, and other types of data structures may be employed according to the necessity.

Descriptions of the HP displaying system 200, 300 above assume the configuration in which the recording/reproducing system 100 with the recording/reproducing device 10 connected to the output device 30, server 220, 320, and terminal unit 230, 330 each as a display control system are connected to each other via the network 210, but the present invention is not limited to this configuration, and also the configuration is allowable in which, for instance, a computer as a computing section is used, and further a program for making a computer execute the processing described above and also a recording medium with the program recorded therein are within a scope of the present invention. The same is applicable also the recording/reproducing device 10, terminal unit 230, and server 320 each as a display controller. Further the computer as a computing section is not limited to a personal computer, and the configuration may be employed in which a plurality of computers are connected to each other to form a network, or in which a chip such as a microcomputer or a circuit board with a plurality of electronic parts mounted thereon is used.

The specific structures and procedures as described above may be changed according to the necessity within the range in which the objects of the present invention can be achieved.

[Advantages of Embodiments]

With the embodiments of the present invention as described above, the recording/reproducing device 10 of the recording/reproducing system 100 includes the contents information generating section 25B for fetching contents data reproduction data and time, the GFX 17 for changing an expression of the thumbnail image 50i associated with contents data according to the number of lapsed days since the date and time when the contents data was reproduced, and the thumbnail generating section 25C. With the configuration as described above, the recording/reproducing device 10 changes an expression of the thumbnail image 50i according to the number of lapsed days from the date and time for reproduction of the contents data fetched by the contents information generating section with the GFX 17 and the thumbnail generating section 25C. Because of this feature, a user can easily recognize the number of lapsed days since the contents was reproduced last from an expression of the thumbnail image 50i. Therefore, a user=s taste to contents indicated by the number of lapsed days since the contents data was reproduced last can easily be recognized.

In another embodiment of the present invention, the terminal unit 230 of the HP displaying system 200 includes the access time updating section 236C for fetching a date and time for reproduction of contents data, and the icon processing section 236B for changing an expression of the icon image 60i associated with the contents data according to the number of lapsed days from the date and time for reproduction of the contents data. With the configuration as described above, the terminal unit 230 changes an expression of the icon image 60i according to the number of lapsed days from the date and time for reproduction of contents data fetched by the access time updating section 236C with the icon processing section 236B. Because of this feature, the user can easily recognize the number of lapsed days since the contents data was reproduced last from an expression of the icon image 60i.

Therefore, the user=s taste to contents indicated by the number of lapsed days since the contents data was reproduced last can easily be recognized.

In still another embodiment of the present invention, the server 320 of the HP displaying system 300 includes the access time updating section 323B for fetching date and time for reproduction of contents data, and the icon processing section 323A for changing an expression of the icon image 60i associated with contents data according to the number of lapsed days from the date and time when the contents data was reproduced last. With the configuration as described above, the server 320 generates, with the icon processing section 323A, a virtual graphics plane for changing an expression of the icon image 60i to be displayed on the display section 233 of the terminal unit 330 according to the number of lapsed days since the date and time of reproduction of the contents data fetched with the access time updating section 323B, and transmits the virtual graphics plane to the terminal unit 330. The terminal unit 330 has the icon image 60i displayed on the display section 233 according to the virtual graphics plane transmitted from the server 320. Because of this feature, a user can easily recognize the number of lapsed days since the contents data was reproduced last from an expression of the icon image 60i. Because of this feature, the user=s taste to contents indicated by the number of lapsed days since the contents data was reproduced last can easily be recognized.

1. A display controller for controlling a display of a representative still image associated with contents data, the display controller comprising:
a storage section for storing a reproduction date and time of the contents data; and
an expression changing section for changing an expression of the representative still image associated with the contents data based on the number of lapsed days since a reproduction date and time of the contents data.

2. The display controller according to claim 1, wherein the expression changing section obtains the number of lapsed days by computing a time difference between a display request date and time of the representative still image and the reproduction date and time of the contents data.

3. The display controller according to claim 1, wherein the storage section stores the reproduction date and time of the contents data when a contents reproduction period of time in which the contents data is reproduced becomes equal to or more than a prespecified period of time.

4. The display controller according to claim 1, wherein the expression includes at least one of transparency, color tone, presence of display, and size change.

5. The display controller according to claim 1, wherein the expression changing section generates the representative still image from the contents data and changes the expression of the representative still image.

6. A display control method for displaying a representative still image associated with contents data, the method comprising:
a storing step for storing a reproduction date and time of the contents data; and
an expression changing step for changing an expression of the representative still image associated with the contents data based on the number of lapsed days since a reproduction date and time of the contents data up to a display date and time of the representative still image.

7. A recording medium storing in the readable state a program for executing a display control method for displaying a representative still image associated with contents data,
the display control method including:
a storing step for storing a reproduction date and time of the contents data; and
an expression changing step for changing an expression of the representative still image associated with the contents data based on the number of lapsed days since a reproduction date and time of the contents data up to a display date and time of the representative still image.
